(19) United States
(12) Patent Application Publication
(10) Pub. No.: US 2024/0025194 A1
(43) Pub. Date: Jan. 25, 2024

(54) SECURITY DEVICE AND METHOD OF MANUFACTURE THEREOF

(71) Applicant: DE LA RUE INTERNATIONAL LIMITED, Basingstoke, Hampshire (GB)

(72) Inventors: Felicity CHILD, Basingstoke (GB); Chris WILCOX, Basingstoke (GB); Brian HOLMES, Basingstoke (GB)

(73) Assignee: DE LA RUE INTERNATIONAL LIMITED, Basingstoke, Hampshire (GB)

(21) Appl. No.: 18/036,425

(22) PCT Filed: Nov. 11, 2021
(86) PCT No.: PCT/GB2021/052915

§ 371 Date: May 11, 2023

(30) Foreign Application Priority Data
Nov. 17, 2020 (GB) 2018041.0

(51) Int. Cl. B41M 3/14; B42D 25/382; B42D 25/324; B42D 25/405

(52) U.S. Cl. CPC B41M 3/148; B42D 25/382; B42D 25/324; B42D 25/405

(57) ABSTRACT

A security device includes: a substrate having a reflective surface; and a printed array of elements on a substantially flat area of the substrate. Each element is formed of a first material which is at least semi-transparent and a second material, the materials having different optical characteristics. Each element has a raised surface profile relative to the substrate including at least first and second sides sloping from the top of the element to at least respective edges of the element, at which the sides meet a substantially flat base surface of the element parallel to the substrate. The sides have different orientations and each lie at an acute angle to the substrate normal. Under illumination away from the substrate normal, when viewed from first and second viewing angles the element appears to have respectively substantially the optical characteristics of the first and second materials.

This invention relates to security devices such as may be used as a mark of authenticity associated with an object of value, such as a security document including banknotes, passports, certificates, licences and the like. Methods for manufacturing security devices are also disclosed.

Objects of value, and particularly documents of value such as banknotes, cheques, passports, identification documents, certificates and licences, are frequently the target of counterfeiters and persons wishing to make fraudulent copies thereof and/or changes to any data contained therein. Typically such objects are provided with a number of visible security devices for checking the authenticity of the object. Examples include features based on one or more patterns such as microtext, fine line patterns, latent images, venetian blind devices, lenticular devices, moiré interference devices and moiré magnification devices, each of which generates a secure visual effect. Other known security devices include holograms, watermarks, embossings, perforations and the use of colour-shifting or luminescent/fluorescent inks. Common to all such devices is that the visual effect exhibited by the device is extremely difficult, or impossible, to copy using available reproduction techniques such as photocopying. Security devices exhibiting non-visible effects such as magnetic materials may also be employed.

Security devices which have an optically variable appearance—i.e. their appearance is different at different angles of view—have been found to be particularly effective since the authenticity of the device can be readily checked by tilting or rotating the device and observing the expected change in appearance. Photocopies of such devices will, on the other hand, have a static appearance which does not change as the viewing position is altered.

Various different mechanisms for forming optically variable devices are known. One class of security devices utilises raised structures, such as line elements, with a contrasting colour to that of the surface on which they are formed. For instance, WO-A-2005/080089 discloses a security device having raised lines formed of or carrying an ink, arranged on a reflective surface. In each of at least three segments of the device, the lines are configured to extend in different respective directions. When viewed at an angle, the raised lines will conceal the reflective surface between the lines to a greater or lesser extent in each of the the three segments, resulting in a contrast between the segments. As the viewing angle is changed, so will the amount of the reflective surface concealed in each segment by the line structure, giving rise to a movement effect across the segments. Disclosed techniques for forming the raised line structure include intaglio printing, printing followed by embossing and screen or thermographic printing.

Another example of a device utilising a raised line structure is disclosed in US-A-2005/0240549, in which a data carrier is printed with a screen in a first ink and then an overlapping embossed structure is formed, typically by intaglio printing such that it carries a second ink, which is transparent but carries a tint, on the raised regions. The printed screen elements come to lie on portions of the raised embossed structure with the result that the screen will be more or less visible (through the second ink) at different angles of view, thereby changing the appearance of the device.

There is a constant need to develop new security devices in order to stay ahead of would-be counterfeiters.

In accordance with the present invention, a security device comprises:
a substrate having a reflective surface; and
a printed array of elements on a substantially flat area of the substrate, each element being formed of at least a first material which is at least semi-transparent and a second material, the first and second materials having different optical characteristics from one another, and each element having a raised surface profile relative to the substrate including at least first and second sides sloping from the top of the element to at least first and second respective edges of the element, at which the first and second sides meet a substantially flat base surface of the element parallel to the substrate, the first and second sides having different orientations from one another and each lying at an acute angle to the substrate normal as measured at the respective edge of the element;
wherein each element of the printed array comprises:
   a first edge portion which defines at least the first edge, part of the first side of the element, and part of the flat base surface of the element, and which is formed substantially only of the first material, such that the optical characteristics of the first material control the appearance of light reflected by the reflective surface through the first edge portion;
   a second edge portion which defines at least the second edge, part of the second side of the element, and part of the flat base surface of the element, and which is formed substantially only of the second material, such that the optical characteristics of the second material control the appearance of light reflected by the second edge portion or by the reflective surface through the second edge portion; and
   a middle portion which is located between the first and second edge portions and across which at least the first and second materials are both present;
      such that, under illumination by light from a fixed direction away from the substrate normal, when viewed from a first viewing angle the element appears to have substantially the optical characteristics of the first material and at a second (different) viewing angle the element appears to have substantially the optical characteristics of the second material.

This construction of the printed elements thus leads them to exhibit a variable optical appearance, which can be employed to create numerous different security effects as will be discussed below. Significantly, the raised nature of each element (which consists only of printed materials) is achieved by the overlapping materials themselves and does not involve embossing of the substrate, which remains substantially flat (i.e. planar). The first and second materials form the flat base surface of each element (adjacent the flat substrate, and parallel to its plane), the sloped sides and top of each element, and the interior volume of each element (i.e. the portion of the element between its flat base and its upper surface which includes the sloped sides and top). More specifically, in the first edge portion the first material forms the flat base surface of the element and the first (sloped) side of the element (and the volume in between them). In the second edge portion, the second material forms the flat base surface of the element and the second (sloped) side of the element (and the volume in between them). Thus the first and second materials themselves provide the three-dimensional shape of each element, and there is no underlying relief structure. Preferably the first and second materials are in direct contact with the substrate, but if any intermediate layer(s) are provided between the first and second materials, such intermediate layer(s) should also be flat.

Each element can exhibit at least two different appearances (depending on the number of materials used to form the element), e.g. switching between a first colour and a second colour, or between a first colour and a colourless state. This allows for the formation of more complex security effects as compared with conventional approaches. It should be noted that this effect may be referred to hereinafter in places as a “colourshift” effect, for brevity. However, as noted above in some embodiments it may not in fact involve a shift from one colour to another but could involve the appearance and disappearance of a single colour, for instance. It may alternatively involve a shift between a luminescent and a non-luminescent appearance, or some other effect involving non-visible wavelengths, as explained below. The term “colourshift” as used herein is intended to cover all such options unless otherwise specified.

This effect is achieved through the differently-orientated first and second sides of the element being angled relative to the substrate surface, as well as being formed of different materials, in combination with the underlying reflective surface. As explained in more detail below, incident light striking the first side from an off-axis position will pass through the first material (which is at least semi-transparent), and be reflected by the reflective surface along a direction which depends on the orientation of the first side of the element (due to refraction occurring at the interface between the element and its surroundings). When the element is viewed from that direction, it will therefore appear to have optical characteristics determined by the first material.

Light which is incident on the second side of the element will either be reflected by the second material itself (e.g. if the second material is opaque, or near opaque), or by the underlying reflective layer (if the second material is at least semi-transparent) in much the same way as at the first side. This light will be reflected along a different direction which depends on the orientation of the second side of the element (due to either reflection or refraction taking place at that interface). Hence when the element is viewed from this direction, it will therefore appear to have optical characteristics determined by the second material. As such when the viewing position is changed between the two directions, the appearance (e.g. colour) of the element also appears to change. It should be noted that the element may exhibit still further different appearances at other angles of view—for instance, when viewed along the normal, a mixed appearance resulting from the overlapping materials may dominate.

It should be noted that, while each element in the array will comprise at least first and second materials as set out above, the specific materials need not be the same in all of the elements. In other words, each element will be formed of at least two materials, but in some embodiments these may be different materials in different elements. This can be used to create particularly complex security effects as described below. In other embodiments, however, each of the elements may comprise the same materials as one another—i.e. the same first material and the same second material. Additional printed elements which do not have all the features set out above could also be present in or near the device, e.g. on the same substrate.

The printed elements may or may not be disposed directly on the reflective surface of the substrate. As described below, the substrate could take a number of forms including that of a support layer with the reflective layer carried thereon. In this case, provided the support layer is transparent, the printed elements could be disposed either on the same side as the reflective layer (i.e. on the reflective layer), or on the opposite side of the substrate. In either case, as noted above, the surface on which the printed elements are disposed remains substantially flat in the sense that there is no relief of the same scale as that of the printed elements (it will be appreciated that, in practice, such substrates are typically flexible and thus might be curved or folded during handling but such deformations will be on a scale which is many orders of magnitude greater than the relief of the printed elements).

As explained below, the cross-sectional shape of the element could take various different forms. The top of the element is that part of the element which has the greatest height (i.e. is most distant from the surface of the underlying substrate). This could be a single point (e.g. if the element is triangular or curved), or could be an area (e.g. if the element has a flat top). The top of the element is typically at an interior part of the element (i.e. not at an edge of the element), but this is not essential.

The sides of the element are defined by the interface between the materials forming the element and their surroundings (e.g. air, or a protective layer which might be coated over the top), and as indicated above lie at an acute angle to the substrate normal as measured at each edge. (The internal angle between the side of the element and the base surface of the element will be 90 degrees minus this acute angle). The edges of the element are those locations at which the height of the element reaches its minimum, preferably zero. An “acute angle” is one greater than zero degrees and less than 90 degrees. It will be appreciated that the first and second sides need not lie at the same acute angle to the normal as one another, although this is preferable in many embodiments. It should also be noted that the sides of the element are not necessarily planar but in many cases will have curvature, in which case the angle between the side of the element and the normal will vary between the edge and the top of the element. Typically, the angle will always remain within the range greater than zero and less than 90 degrees, however. The base surface of the element is the interface between the element and the carrier on which the materials forming the element are supported, which may be the substrate itself or an intervening layer such as a primer. The substrate and any intervening layer is flat and so the base surface of the element is also flat.

In the middle portion of each element, the first and second materials may overlap one another but remain distinct, or may be mixed together (homogeneously or otherwise). Either way, across the middle portion at least the first and second materials are both present—that is, both the first and second materials are present at every lateral point of the middle portion (optionally in varying proportions). It is the provision of both materials in this portion which creates the raised profile of the element with sloped sides, giving rise to the optically variable appearance already described. The middle portion may or may not be semi-transparent, depending on the nature of the first and second materials. It should also be noted that while the middle portion is between the first and second edge portions (since it is formed where they overlap), it may not wholly separate the edge portions from one another, which could abut elsewhere without overlapping, depending on the configuration of the element.

Light which is reflected by or through anywhere in the middle portion of the element will interact with both the first and second materials. Depending on the optical characteristics of the first and second materials, the middle portion may itself have an optical characteristic which is different from either of the first and second edge portions. The exception is where one of the first and second materials does not modify the optical characteristics of the other of the first and second materials despite both being present throughout the middle portion (e.g. if one of the first and second materials is clear and colourless under all illumination conditions and detection wavebands).

The first and second sides of the element can have different positions relative to one another depending on the lateral (plan view) shape of the element. Preferably, the first and second sides of each element are opposing sides of the element and the first and second edges are opposing edges of the element. For instance, where the elements are line elements, there may only be the two opposing sides of the element and no more. However, in other cases if the element as some other shape (such as triangular, square etc) there may be more sides (and edges) and the first and second sides could be any two of them, e.g. adjacent sides or opposing sides.

As described above, the element generally has a raised shape with a top and at least two sides sloping down from the top to the edges of the element. This could take various forms and in preferred examples, each element has a cross-section which is shaped as any of: a dome, a bell-curve, a triangle or a trapezium. The shapes could be regular, i.e. approximately symmetrical about their centre (which preferably corresponds to the top of the element), or could be irregular, i.e. asymmetrical. Curved shapes such as domes (which need not be hemi-spherical) or bell-curves (approximately the shape of a normal distribution) are particularly preferred since these can be formed using the natural surface tension of the materials and overlapping them as described below in relation to the preferred methods of manufacture. Hence casting, moulding or impressing of the shape is not required.

In some preferred embodiments, each element has an elongate lateral shape (i.e. the footprint of the element in plan view), the elements preferably being line elements such as rectilinear line elements, curved line elements, sinusoidal line elements or zig-zag line elements. The line elements could be continuous or broken lines. In other preferred embodiments, each element has a non-elongate lateral shape, the elements preferably being any of: dots, circles, ovals, squares, triangles, alphanumeric characters or other symbols.

Preferably, the first and second sides of each element each lie at an acute angle (i.e. greater than zero and less than 90 degrees) to the substrate normal as measured at the respective edge of the element which is greater than or equal to degrees and less than 90 degrees, preferably greater than or equal to 70 degrees and less than or equal to 85 degrees. Slope angles of this magnitude have been found to give good results, with the two different appearances of the element being visible at adequately separated positions (so that the colour change can be viewed gradually rather than instantaneously) but without requiring an unduly large tilt of the device.

Advantageously, the top of each element has a height of at least 5 μm relative to the substrate, preferably at least 8 μm, more preferably at least 10 μm. Such heights provide a particularly good optically variable effect, and are achievable via the preferred manufacturing techniques disclosed below. Preferably, the top of each element has a height relative to the substrate of 50 μm or less, more preferably 30 μm or less, still preferably less than 30 μm. As indicated above, the “height” of the element is the distance from the interface between the materials and their surroundings (e.g. air or a varnish/lacquer if used) to the surface of the substrate, which is substantially flat. Since the base surface of the element is against the substrate (and is also substantially flat), the height is equivalent to the thickness of the material(s) between the top of the element and the base surface of the element.

In preferred embodiments, each element has a lateral width in the range 30 to 500 μm, preferably 50 to 300 μm, more preferably 100 to 200 μm. It should be noted that these values correspond to the actual width of the element in the finished product. Typically the “design width” (i.e. the width which the printer forming the elements is controlled to lay down) will be narrower than the actual width in the end product, due to spreading of the materials (e.g. inks) on the substrate surface. The amount of spreading (and hence the degree to which the design width will be smaller than the actual width) will depend on factors including the viscosity of the materials, the mechanism used to fix them (e.g. drying and/or curing), the nature of the substrate surface and potentially other process conditions such as temperature. A person skilled in printing will however be able to choose an appropriate design width for the circumstances so as to arrive at the desired actual width of the elements in the final product. Element widths in the above ranges have been found to produce a good visual effect whilst being achievable via a wide range of printing techniques. Generally it is desirable to keep the element width reasonably small (e.g. less than 200 μm) so that the elements are not individually discernible to the naked eye but rather the colour(s) presented by multiple elements are combined by the eye to give the appearance of an area of colour.

The amount of overlap between the first and second materials (i.e. the extent of the middle potion) has a significant influence on the colourshift effect exhibited by the element. If the amount of overlap is too small, it has been found that the necessary relief shape of the element may be hard to achieve and/or the height of the element top may be too low to produce good separation between the viewing angles at which the different appearances are visible. However, if the middle portion occupies too much of the element, there is too much mixing between the two appearances and the distinct colours of the two materials (or other appearances) may only be seen weakly and/or only very briefly during tilting. Hence, preferably, in each element, the middle portion occupies between 5% and 60% of the lateral area of the element, preferably between 10% and 50%, most preferably between 20% and 40%. Thus, for typical elements, the middle portion advantageously has a lateral width in the range 20 to 80 μm, preferably 30 to 50 μm.

Preferably, in each element, the first and second edge portions occupy approximately equal proportions of the lateral area of the element as one another. This ensures the two appearances have approximately the same intensity as one another and are each visible over respective viewing angle ranges of similar size.

The array of printed elements may be regular or irregular. For instance, the elements could be arranged on a one dimensional or two-dimensional grid (orthogonal, hexagonal or otherwise). The array could also be different in different parts of the device, e.g. regular in one part and irregular in another.

The elements may or may not be spaced from one another, provided their individually domed (or other shape) nature is retained. In some preferred embodiments, the elements abut one another at at least some of their edges. This maximises coverage of the substrate and therefore achieves the highest colour density appearance of the device. In other preferred embodiments, the elements are spaced from one another, the spacing between the edges of neighbouring elements preferably being in the range of 5 to 100 μm, preferably 5 to 60 μm, most preferably 10 to 30 μm. Desirably, the spacing is sufficiently small such that the elements cannot be individually resolved by the naked eye. If wished, the complexity of the security device can be further increased by arranging the spacing between the elements to vary across the device, which will give rise to a corresponding variation in the colour density exhibited by the device, which will affect both the first and second appearances of the elements equally and will therefore remain apparent at all viewing angles. Preferably the variation of the spacing is in accordance with a static image, so termed because the same image (with constant image content) will therefore remain visible at all viewing angles even though it will exhibit the colourshift effect.

As indicated above, the elements could have various shapes and may have more than two sides. In this case, two or more of the sides could be formed by the same material (e.g. the first or the second material already mentioned). However, in preferred embodiments, each element further comprises a third material which has different optical characteristics from those of the first and second materials, each element further including a third side sloping from the top of the element to a third respective edge of the element, the third side lying at an acute angle to the substrate normal as measured at the third edge of the element and having a different orientation from those of the first and second slides, wherein each element further comprises a third edge portion which defines at least the third edge and part of the third side of the element, and which is formed substantially only of the third material, such that the optical characteristics of the third material control the appearance of light reflected by the third edge portion or by the reflective surface through the third edge portion, and the middle portion further comprises the third material, such that, under illumination by light from a fixed direction away from the substrate normal, when the device is viewed from a third viewing angle the element appears to have substantially the optical characteristics of the third material. It will be appreciated that the element could have any number of sides and respective materials with different appearances (i.e. two or more, three or more, four or more . . . , etc.), provided the sides can be formed with different orientations to one another. The greater the number of materials used (and corresponding sides), the more complex the designs of security device that can be achieved, and hence the higher the security level.

Alternatively or in addition, the security level could be enhanced by providing an array of overlay elements, each overlay element covering part of one of the elements, at least part of one or more (preferably all) of the edge portions of each element remaining uncovered by the overlay element, wherein each overlay element is formed by an overlay material which is preferably substantially opaque. This can be used to arrange for the dominant appearance (e.g. colour) of the element when viewed along the substrate normal to be something other than that of the combination of materials found in the middle portion of the element. This gives a more distinct and surprising colourshift effect, since the appearance visible from the normal can be entirely independent of the appearances from other angles, rather than necessarily being a mix of the two. For instance, the overlay elements could be black, such that the elements appear generally black when viewed from the normal, but take on different colours when viewed from the particular angles at which the appearances of the first and second (and any further) materials are visible. The configuration of the overlay element such that it does not cover up the edge portions of the underlying element ensures that a colourshift effect remains visible. The overlay element could be semi-transparent (e.g. with a coloured tint), such that it modifies the appearance of the middle potion of the element seen therethrough, but preferably is substantially opaque so as to give a more distinct impression.

As explained above, at least the first material is at least semi-transparent, so that in the first edge portion light is predominantly reflected to the viewer by the underlying reflective layer, being refracted at the opposite surface of the element. This gives rise to a brighter appearance as compared with colours exhibited by standard opaque inks (due to the relatively specular nature of the reflection), and there is a clearer switch between the two appearances of the element as compared with more diffuse elements. Also, compared to known devices, the resulting visual effect is unexpected since the first appearance will be seen at a position on the side of the element opposite from the first edge, due to the geometry of the element/reflective surface combination. The second material need not be semi-transparent since the mechanism by which light is directed to the viewer in the second edge portion can be different (e.g. reflected by the surface of the second edge portion). However, it is preferable that light is directed to the viewer by the same mechanism in both portions. This is particularly desirable since the geometry of the element/reflective surface combination can then be arranged such that the first and second appearances of the device are visible at viewing positions which are “reversed” relative to the actual arrangement of the materials (examples will be shown below), which is a particularly unexpected visual effect. Hence, preferably the second material is at least semi-transparent. This also applies to any further material that may be used to form the element, such as the third material mentioned above. “At least semi-transparent” means that the material is substantially clear (i.e. produces low or zero optical scattering) but may carry a coloured tint. As a result light passes through the material in a substantially straight line but some wavelengths may be absorbed or attenuated. The term also encompasses clear, colourless (i.e. wholly visually transparent) materials.

Advantageously, the first material has an optical density of less than 0.9, preferably less than 0.8, more preferably less than 0.7. The same preferably applies to the second, third and any subsequent materials used to form the elements, if they are semi-transparent. Optical density is a dimensionless ratio and is measured on a transmission densitometer, with an aperture area equivalent to that of a circle with a 1 mm diameter. A suitable transmission densitometer is the MacBeth T0932.

The materials forming the element could differ in various different respects provided some aspect of their appearance is different from one another. In most preferred cases this difference will be apparent to the naked eye under normal viewing conditions, but this is not always essential. Thus, in some preferred implementations, the optical characteristics of the first and second materials are such that, to the naked eye, the appearance of the first material is different from the appearance of the second material under white light illumination (i.e. a combination of all visible wavelengths). This is desirable so that no special equipment is required in order to be able to perceive the colourshifting effect.

Preferably, the first and/or second material has a colour which is visible to the naked eye under white light illumination; the colour of the first material preferably being different to that of the second material (if both have a colour—one or other of the materials could alternatively be colourless). Advantageously, the first and/or second material comprises a visible colourant, preferably a pigment or a dye. Thus, the first material may be visibly coloured while the second material is colourless (or vice versa), or both materials might have different visible colours, or both materials might have the same visible colour under white light illumination (but in this case they must have some differing optical characteristics under other illumination conditions, e.g. UV luminescence). On the other hand both materials could be colourless under white light illumination if again they will appear different under other illumination conditions, e.g. UV luminescence. Thus in some preferred embodiments, the first and/or second material is responsive to at least one excitation wavelength, preferably an IR or UV wavelength, such that to the naked eye, the appearance of the first material is different from the appearance of the second material under illumination by the at least one excitation wavelength. Advantageously, the first and/or second material may comprise a luminescent substance, preferably a fluorescent or phosphorescent substance.

Typically, the first and second materials (and any other materials used to form the elements) are inks, which may be dried or cured inks depending on their composition. Inkjet inks are particularly preferred due to their viscosity and relatively high transparency. Examples of suitable ink formulations are given below.

As already mentioned above, it should be noted that while each element will include first and second materials as already defined, the first and second materials may not be the same in all of the elements. In other words, the first material forming the first side portion in one element may be a different first material from that forming the first side portion in another element of the array—e.g. a different colour. Examples of how this can be put to use to make particularly complex devices will be described below. However, in many preferred implementations, at least in a part of the device, preferably across the whole device, every one of the elements comprises the same first material and the same second material. This has the result that all of the elements in that part of the device are able to exhibit the same appearances (e.g. colours) as one another, even if they do not do so at the same viewing angle.

The reflective surface should be of sufficient quality that it reflects incident light without significant scatter, so as to maintain the directional nature of the light and keep a separation between the viewing positions at which the different appearances are visible. Most preferably, therefore, the reflective surface is substantially specularly reflective. It should be noted that the reflective surface may be substantially opaque (e.g. a relatively thick metallic layer), semi-opaque (e.g. a relatively thin metallic layer) or transparent (e.g. a polymeric material with a glossy surface). The whole substrate could be formed of a reflective material (e.g. a self-supporting layer of metal or metal alloy, or a polymeric film with a glossy surface). However, as mentioned above, the substrate advantageously comprises a carrier layer and a reflective layer disposed thereon, the reflective layer forming the reflective surface of the substrate, the carrier layer preferably being transparent. Suitable materials for forming the carrier layer include polymeric materials such as BOPP, PET or PC. However, paper or other fibrous materials could be used if they are calendared or otherwise provided with a sufficiently smooth surface to apply an adequately reflective surface thereon.

Depending on the nature of the carrier layer, the elements could be located on either side of the substrate—that is, the printed array of elements may be disposed on the carrier layer or on the reflective layer. The latter will be required if the carrier layer is not transparent. It should be noted that the term “on” as used herein does not impose any particular orientation (an item may be “on” the underside of another item, or “on” top of it), and nor does it require direct contact—for instance there may be an intermediate layer between the printed elements and the substrate, such as a primer layer, provided this is sufficiently transparent so as not to impede the above-described optical effect.

If a reflective layer is used, it is preferably substantially opaque or at least semi-opaque. In preferred embodiments, the reflective layer comprises any of: a metal layer, a metal alloy layer, a metallic ink layer, a thin-film interference layer structure or a foil. Desirably, such metal or metal alloy layers or indeed thin-film interference structures may be vapour-deposited to achieve a highly specular result. If a metallic ink (or other reflective ink) is used, which typically comprise reflective flakes in a binder, it is preferable to arrange the reflective layer on the opposite side of the carrier layer from the printed elements. This is because the contact between the ink and the flat surface of the carrier layer will encourage the reflective flakes to lie substantially parallel to the surface, at least locally, so a reasonably specular reflective surface will be presented to the viewer.

However the reflective surface is formed, like the substrate as a whole, it will be generally flat (at least relative to the surface relief of the printed elements) in the area of the printed array. It could nonetheless be provided with an additional optically variable surface relief structure formed in the reflective layer such as a diffractive relief defining a diffraction grating, a hologram, a Kinegram® or the like. Such reliefs will be on the nanometer scale, far below the scale of the printed elements' relief. This results in a particularly complex security device since the diffractive effect and the above-described colourshift effect will be superimposed on one another.

Other ways of increasing the security effect include combining the device with other features as may be located on the substrate. For instance, in a preferred embodiment the security device further comprises an opacifying layer disposed on the substrate laterally adjacent the array of elements, the opacifying layer preferably covering some of the array of elements. An opacifying layer is typically a semi-opaque translucent material with high optical scattering, such as a white ink. In polymer banknotes (and other security documents) such layers may be provided on a transparent polymer substrate to form a more opaque, printable area thereon. One or more window regions are typically left free of opacifying material on at least one side of the substrate (preferably both). The above-described printed array and reflective layer combination may be provided in such a window region and, to increase the complexity still further, part of the array could be overlapped by the opacifying layer. Depending on the opacity of the opacifying layer, this may result in a more muted colourshift effect in the area of overlapping as compared with that visible in the window portion. Alternatively, if the opacity is higher, in the overlap area the colourshift effect may be extinguished and the device may no longer be visible there in reflection. In both cases, when the arrangement is viewed in transmitted light, the edge of the device (e.g. the periphery of the reflective layer) located under the opacifying layer may become apparent.

The disclosed array of elements can be configured in various different ways in order to achieve different security effects. In a first category of preferred devices, in at least a first region of the security device, the elements have a same first configuration, such that under illumination by light from a fixed direction away from the substrate normal, when viewed from the first viewing angle the first region appears to have substantially the optical characteristics of the first material and at the second viewing angle the first region appears to have substantially the optical characteristics of the second material. By “same first configuration” it is meant that the elements are formed identically to one another—i.e. being formed of the same materials in the same arrangement, and having the same shape and orientation. This “first configuration” may be different from configuration(s) of elements elsewhere in the security device as explained below. Since all of the elements in the first region have the same configuration as one another, they will all exhibit the same colourshift effect as one another (i.e. the same appearance at the same viewing angle) such that the whole region will behave uniformly upon tilting.

In some implementations, the first region could include the whole device. However, in more preferred embodiments, in a second region of the security device, the elements of the printed array have a same second configuration which is different from the first configuration of the elements in the first region of the security device, such that, at least at one viewing angle, the appearance of the second region is different from the appearance of the first region, and preferably the appearance of the second region is substantially the same as the appearance of the first region at at least one other viewing angle. Like the first region, the second region will thus behave uniformly upon tilting, but its behaviour will be different to that of the first region. This increases the security level of the device and can be used to give rise to a number of different security effects.

For instance, in some preferred embodiments, the orientation of the elements in the second region is different from that of the elements in the first region. It should be noted that elements with different orientation can have the same footprint as one another, the peripheries thereof having the same direction in both elements, but in such a case the arrangement of materials therein would be different. As an example, two parallel line elements each formed of a first material which is red and a second material which is blue will have different orientations if one has the red portion on the left and the other has the red portion on the right side thereof (i.e. the sequence of materials is swapped). Similarly, two square elements arranged with their adjacent sides parallel to one another and each formed of the same four materials can have different orientations if the position of the materials is different in the two elements—for instance, both elements may have the same sequence of materials red, blue, green, yellow arranged clockwise about the centre of the element. In the first element, red may be at the 12 o'clock position whilst in the second element, red may be at the 3 o'clock position. These elements have different orientations.

Alternatively or in addition, the elements may preferably have a lateral shape which defines a pattern direction of the array, the pattern direction lying in the plane of the security device, and the elements are arranged such that the pattern direction is different in the first and second regions. For instance, if the elements are elongate (e.g. line elements), the pattern direction could be defined as parallel to the elongate direction of the elements. However, even where the elements are not elongate, provided they do not have infinite rotational symmetry, a pattern direction can still be defined. For instance, in square elements it may be parallel to one of the edges of each element.

If the orientation of the elements differs between regions, but not their pattern direction, this typically has the result that the colourshift effect will occur at the same viewing angles in each region, but different appearances will be visible in each region at the respective angles. For instance, in the case referred to above where both regions contain parallel line elements each formed of a first material which is red and a second material which is blue, but in the first region the elements have the red portion on the left and in the second region the elements have the red portion on the right side thereof, from one viewing angle the first region will appear red and (simultaneously) the second region blue, and from another viewing angle the first region will appear blue and (simultaneously) the second region red.

If the pattern direction of the elements differs between regions, but not their arrangement of materials, this typically has the result that each region will exhibit the same colourshift effect but across different viewing angles. As such, from any one off-axis viewing angle, the two regions will simultaneously have different appearances from one another because the viewer will perceive a different “snapshot” of the appearance transition in each region, depending on how they are positioned relative to the elements in each region. Thus, as the device is tilted or rotated, the various appearances may appear to swap from one region to the other.

In further preferred implementations, the proportion of the lateral area of each element occupied by the middle portion in which the first and second materials are present is different in the first and second regions of the device. This affects the degree to which the colourshift effect can be exhibited by each region. For example, as the degree of overlap tends towards 100%, the colourshift effect will be increasingly inhibited since the mixed colour of the middle portion of the elements will dominate. By varying the amount of overlap between regions, certain regions can be arranged to appear more static than others, allowing for hide and reveal effects upon tilting as the colourshift occurs in some regions and (substantially) not, or less so, in others.

Regions of the device can also be arranged to exhibit different behaviours from one another through the use of different material(s) to form the elements in the respective regions. Hence in some preferred embodiments, the first and/or second material(s) are different in the first region of the device relative to the first and/or second material(s), respectively, in the second region of the device, at least in terms of optical characteristics. It will be appreciated that both materials could differ from region to region, or just one material or the other.

Any combination of the above approaches for obtaining different behaviours in each region could also be employed, to achieve particularly complex effects.

Whilst the use of two regions is sufficient to achieve many security effects (such as switching effects and hide and reveal effects), the provision of further such regions can be used to construct even more complex effects. Hence in preferred implementations, in a third region of the security device, the elements of the printed array have a same third configuration which is different from the first configuration of the elements in the first region of the security device, and from the second configuration of the elements in the second region of the security device, such that, at least at one viewing angle, the appearances of the first, second and third regions are different, and preferably appearances of the first, second and third regions are substantially the same at at least one other viewing angle. Thus the behaviour of the third region is different from that of the first and second regions. Providing at least three different regions in this way is particularly beneficial since this achieves a more dynamic impression and can be used to give rise to a movement effect, depending on how the regions are arranged. It will be appreciated that the concept can be readily extended to the provision of any number of regions with respectively different element configurations and corresponding different behaviours.

Advantageously, the regions of the security device are arranged to define an image which is visible at at least one viewing angle due to the different appearances of the regions giving rise to contrast between the regions; and preferably is not visible at another viewing angle where the appearances of the regions is the same (e.g. along the normal to the substrate). For instance, the image could be in the form of alphanumeric text, one or more symbols (e.g. “£”, “$”), a logo or any other graphic.

In some preferred embodiments, the regions of the device are arranged to extend radially from a point, such that upon tilting of the device the impression of rotation is generated.

Preferably, there are at least three regions of the security device and the regions are arranged so as to exhibit the same change in appearance sequentially in order across the device as the device is tilted, such that the impression of movement is generated. The manner in which this is achieved will depend on how the configurations of the elements vary from one region to the next. For instance, where this is achieved by varying the pattern direction of the elements, the elements may be configured in the various regions such that the pattern direction changes incrementally from one region to the adjacent region. That is, relative to a nominal reference direction, the angle of the pattern direction may increase in increments from one region to the next. Preferably the increments are substantially equal to achieve the impression of movement with uniform speed across the device. The regions could be arranged on the device so as to give any desired movement effect (such as translational movement or the like), but in particularly preferred cases, the regions are arranged concentrically so as to give rise to a radial expansion and contraction effect upon tilting. This has been found to be a particularly memorable and impactful security effect.

Another strong effect is to arrange for the impression of movement to take place in different directions at the same time. Hence in a preferred example, the regions in one part of the device are arranged differently from those in another part of the device such that the movement appears to take place in different directions in the respective parts of the device simultaneously upon tilting of the device. For instance, a concentric arrangement of regions in one part of the device may be configured to give the impression of contracting at the same time (i.e. during the same tilting/rotating action) as another concentric arrangement of regions in another part of the device gives the impression of expanding. Alternatively, a translational movement effect in one part of the device may have the opposite direction (or a non-parallel direction) to that of another translation movement effect in another part of the device. The skilled person implementing the device will be able to form such effects by configuring the regions such that they exhibit the necessary behaviours in the desired sequence.

Depending on the security effect required, the transition from one region to the next adjacent region may be discrete or continuous. A discrete transition will give rise to a more sudden switch or sense of movement upon tilting, whereas a continuous translation will have a smoother visual effect.

Another way to form regions with different behaviours is to stagger the positions of the elements in one region relative to another, and provide a second set of elements which does not vary between regions in the same way so that the parts of the elements which remain visible differ in each region. Hence in a preferred example, the security device comprises an array of overlay elements, each overlay element covering part of one of the elements, at least part of one or more (preferably all) of the edge portions of each element remaining uncovered by the overlay element, the array of overlay elements being uniform across all of the regions, and the elements in each region are laterally offset relative to the elements in the other region(s), such that the overlay elements cover different parts of the elements in each region thereby giving rise to different appearances of each region, at least at one viewing angle. The preferred characteristics of such overlay elements has already been discussed above. Again, this technique could be used alone or in combination with one or more of the techniques disclosed above for providing regions with different behaviours.

In many of the above implementations, all of the elements making up the array will comprise the same materials as one another. However, in other type of device, the individual elements can be used to effectively provide “pixels” of images. For instance, if all of the elements across the device have the same shape and pattern direction (if any), their first edges will all contribute to the appearance of the device from one viewing angle and their second edges will all contribute to the appearance of the device from another viewing angle. Hence the set of first edges can be used to display one image across the device and optionally the set of second edges can be used to display another image across the device, visible at a different viewing angle. To achieve this, preferably, the first edges of the elements are provided with respective first material(s) which vary in optical characteristics across the array in accordance with a first image, the first image being displayed by the elements in combination when the device is viewed at the first viewing angle. Advantageously, the second edges of the elements are provided with respective second material(s) which vary in optical characteristics across the array in accordance with a second image, the second image being displayed by the elements in combination when the device is viewed at the second viewing angle. It may be particularly advantageous if, in combination with this, the spacing between the elements is also varied across the device in accordance with a static image as mentioned above, since this will also be visible when viewed on the normal. It should be noted that the various images might or might not differ from one another in image content. For instance, they might be different colour versions of the same image or could be completely unrelated to one another.

Desirably, the security device may further comprise a protective layer disposed over the printed array of elements, the protective layer comprising a transparent lacquer or varnish, which is preferably colourless. This shields the printed elements from damage during handling and reduces soiling of the security device. The protective layer may either follow the contour of the elements' relief and/or may have a refractive index which is different from that of the materials forming the printed elements. Either way, the necessary optical interfaces (and their orientations) will be preserved. It will be appreciated that the provision of such a layer may change the particular angles at which each appearance is visible (or likewise the incident light angle which achieves the strongest effect), due to a change in the amount of refraction occurring at the element/protective layer interface and/or to the introduction of further refraction points where light enters and exits the protective layer before and after striking the element.

The security device could be formed directly on an object of value or could be formed on a security article which is then attached to or incorporated into such an object, as will be discussed further below.

Thus the invention further provides a security article comprising a security device as described above, the security article preferably being a security label, security thread or stripe, lamination film, data page, transfer element, patch, foil or insert.

The invention also provides an object of value (preferably a security document) comprising a security device or a security article each as described above. Examples of objects of value which may be provided with a security device of the sort disclosed herein include security documents, packaging (such as pharmaceuticals or cigarette packaging), food and drink containers (such as beverage cans and beverage bottles), as well as goods themselves, such as cosmetics or electronic items. Examples of security documents include: an item of currency such as a banknote (preferably a polymer banknote), an identification document, a passport, a visa, a cheque, a certificate, a bank card, a ticket, a driver's licence or a stamp. In all cases, the security device can be marked directly onto the object in question, or can be formed on a security article such as a label which is then applied to the object. If the security device is formed directly on the object of value, a surface of the object of value (which may already be reflective or, if not, a reflective layer is applied thereto) provides the substrate of the above-described security device, and the array of elements is printed thereon. For example, if the object of value is packaging (e.g. for pharmaceuticals or cigarettes), the security device may be formed by printing directly on a portion of the cardboard (or other material) from which the packaging is to be made. This could take place in the same process as printing other graphics onto the cardboard, or in a separate process. Alternatively, as mentioned above the security device may be formed on a security article including a suitable substrate, such as a label, which is then applied to or incorporated into the object of value. For example, the security device could be formed on a metallised polymer substrate forming part of a data page for a passport, which is then incorporated into the passport booklet.

The invention further provides a method of manufacturing a security device, comprising:
providing a substrate having a reflective surface; and
printing an array of elements onto a substantially flat area of the substrate, each element being formed by:
   a) printing a first material which is at least semi-transparent onto the substrate in the form of a first sub-element; and
   b) printing a second material onto the substrate in the form of a second sub-element, the first and second materials having different optical characteristics from one another;
wherein the printing is configured such that the first sub-element and the second sub-element partially overlap one another, thereby forming an element of the array of elements;
whereby each element has a raised surface profile relative to the substrate including at least first and second sides sloping from the top of the element to at least first and second respective edges of the element, at which the first and second sides meet a substantially flat base surface of the element parallel to the substrate, the first and second sides having different orientations from one another and each lying at an acute angle to the substrate normal as measured at the respective edge of the element; and each element comprises:
   a first edge portion which defines at least the first edge, part of the first side of the element, and part of the flat base surface of the element, and which is formed substantially only of the first material, such that the optical characteristics of the first material control the appearance of light reflected by the reflective surface through the first edge portion;
   a second edge portion which defines at least the second edge, part of the second side of the element, and part of the flat base surface of the element, and which is formed substantially only of the second material, such that the optical characteristics of the second material control the appearance of light reflected by the second edge portion or by the reflective surface through the second edge portion; and
   a middle portion which is located between the first and second edge portions and is formed of the overlapping first and second materials;
such that, under illumination by light from a fixed direction away from the substrate normal, when viewed from a first viewing angle the element appears to have substantially the optical characteristics of the first material and at a second viewing angle the element appears to have substantially the optical characteristics of the second material.

The method results in a security device as already described above and with all the attendant benefits. It should be noted that steps (a) and (b) could be performed in either order, such that the first material may be applied on top of the second material or vice versa in the overlapping portion. Also, steps (a) and (b) could be performed for each element independently, with each element being formed in sequence, or multiple elements could be formed at substantially the same time. The latter would be achieved by printing the first edge portions of multiple elements in one process during step (a) and likewise the second edge portions of multiple elements in one process during step (b), as described further below. As explained above, the various elements will each comprise at least first and second materials, but these may be different materials in different elements.

The method may result in the first and second materials remaining distinct from one another (but overlapping) across the middle portion, or they may become mixed together across the middle portion (homogenously or otherwise). The first and second materials are both present across the middle portion, optionally in varying proportions.

The first and second materials could be physically drying materials, which become fixed over a period of time, with or without heating. However, the present inventors have found that superior results are achieved through the use of curable materials.

Hence preferably the first and second materials are curable materials, and the method further includes at least one step of exposing the first and second materials to curing energy to thereby cure the first and second materials. This allows better control over the printing process and ultimately the shape and size of the elements. The first and second materials are preferably radiation-curable materials and the curing energy is preferably curing radiation, most preferably UV radiation.

Curing of the various materials could be performed after they have all been applied, in which case the first and second materials may intermingle to an extent in the middle portion of the element (because the first material is still uncured when the second material is applied). However, in some cases, the first material may be at least partially cured (“pinned”) before the second material is printed onto the substrate, and then the second material is cured. This can assist by providing better control of the element size and shape. If the first material is only partially cured before the second material is applied, its curing will be completed when the second material is cured. If more than two materials are used to form each element, a curing step may be performed between the application of each material and/or after the final material has been applied.

The elements could be formed by any printing technique which maintains a substantially flat surface of the substrate, such as screen printing, gravure printing lithographic printing or flexographic printing, provided sufficient ink is laid down to achieve the necessary relief. However, advantageously, the printing is performed by a digital print method, preferably inkjet printing. This means that no master printing plate or cylinder need be created, with the design existing only in software prior to the elements being printed. This allows for the elements being printed to be changed on the fly, such that if desired each security device can be different from the next. For instance each security device could be individualised to a holder of a security document to which the device is to be applied, e.g. including their portrait or bibliographic information such as their name or date of birth.

Advantageously, the first and second materials are inks, preferably inkjet inks, most preferably curable inkjet inks.

The method may further comprise a step of surface treatment performed on the substrate before printing the array of elements thereon, preferably comprising applying a primer layer to the substrate and/or performing corona treatment. This assists in the retention of the printed elements thereon and hence improves the durability of the device.

As noted above, the elements could be completed one-by-one or multiple elements could be formed in one go. Typically the latter is preferred for speed. Hence preferably, in step (a) the first material is printed to form an array of first sub-elements, and in step (b) the second material is printed to form an array of second sub-elements, at least some of the first sub-elements and second sub-elements partially overlapping one another to form elements of the array. The two steps could be performed by subsequent print heads of a digital printer, for instance.

Advantageously, steps (a) and (b) are performed in register with one another, preferably in an inline process.

As already noted, the device could be formed directly on an object to be protected or on a security article which is then applied to or incorporated in such an object. Hence preferably the substrate is a security article substrate or a security document substrate.

The method may be configured to provide the security device with any of the preferred features discussed above.

Examples of security devices, security documents and methods of manufacture thereof will now be described with reference to the accompanying drawings, in which:

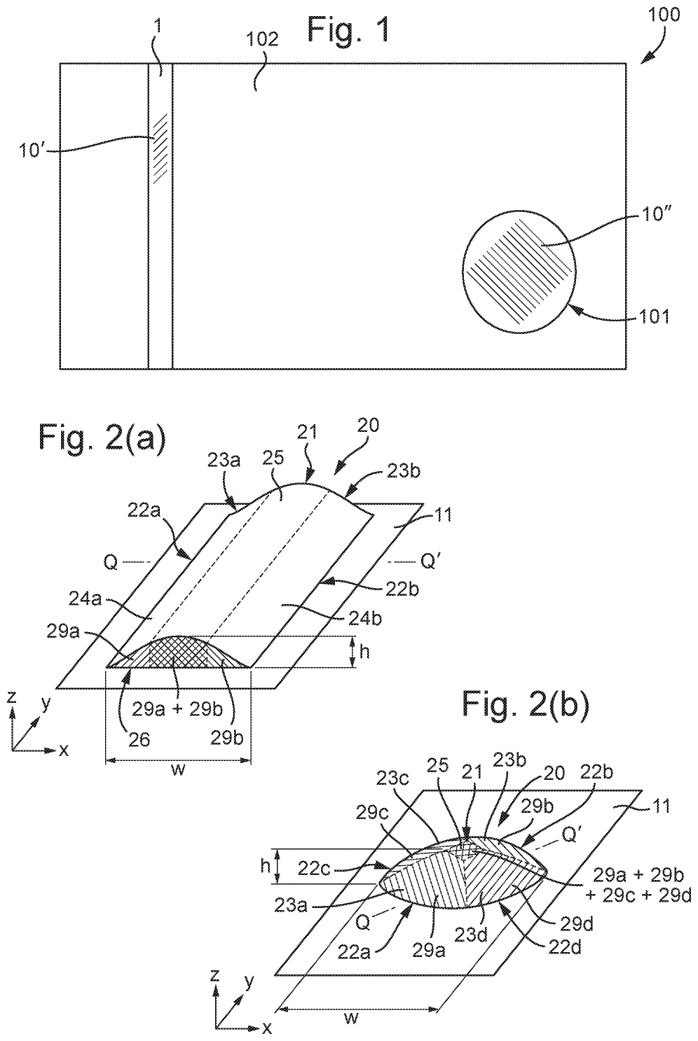

FIG. 1 shows an exemplary security document in plan view;

FIGS. 2(a) and (b) show two examples of printed elements which can form part of security devices in accordance with embodiments of the invention;

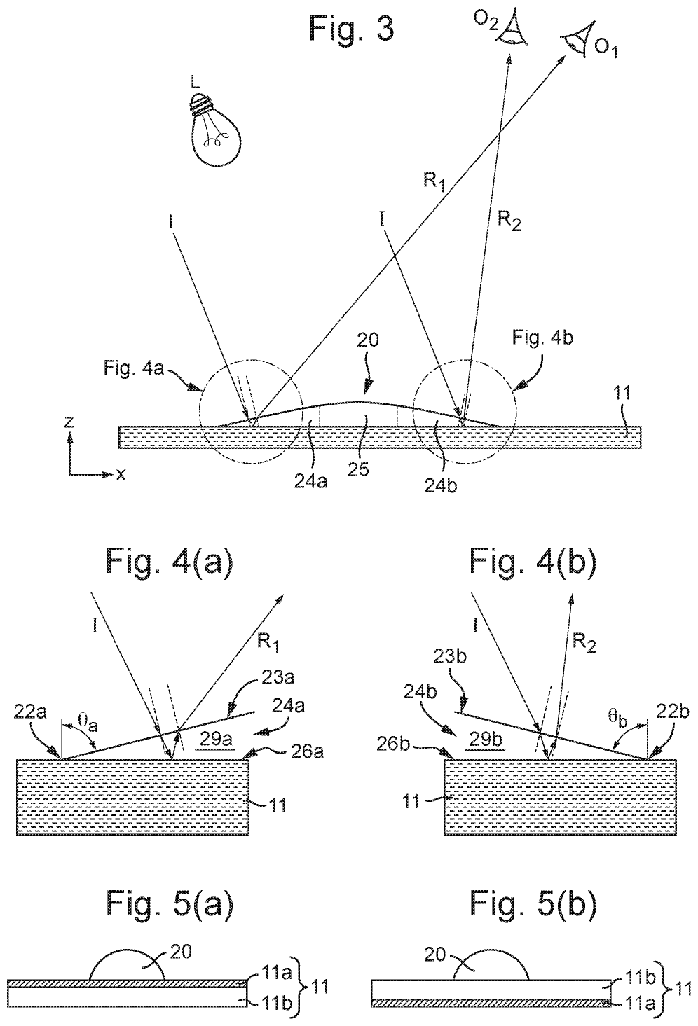

FIG. 3 shows a cross-section through an exemplary printed element forming part of a security device in accordance with an embodiment of the invention;

FIGS. 4(a) and (b) show two enlarged details of FIG. 3;

FIGS. 5(a) and (b) show two further examples of printed elements which can form of a security device in accordance with embodiments of the invention;

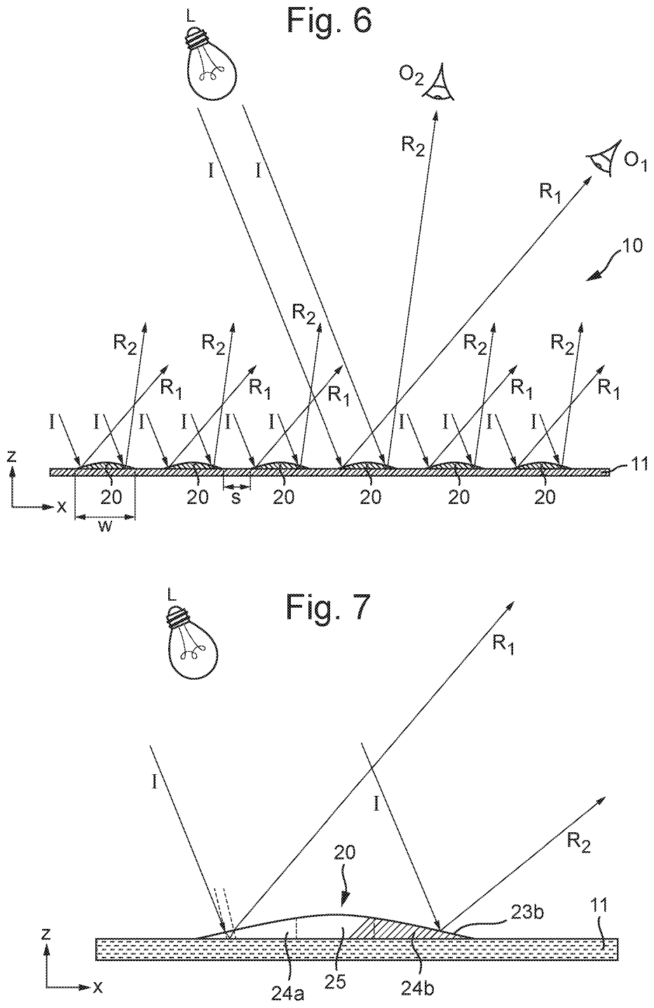

FIG. 6 shows a cross-section through an array of printed elements forming part of a security device in accordance with an embodiment of the invention;

FIG. 7 shows a cross-section through an alternative printed element forming part of a security device in accordance with another embodiment of the invention;

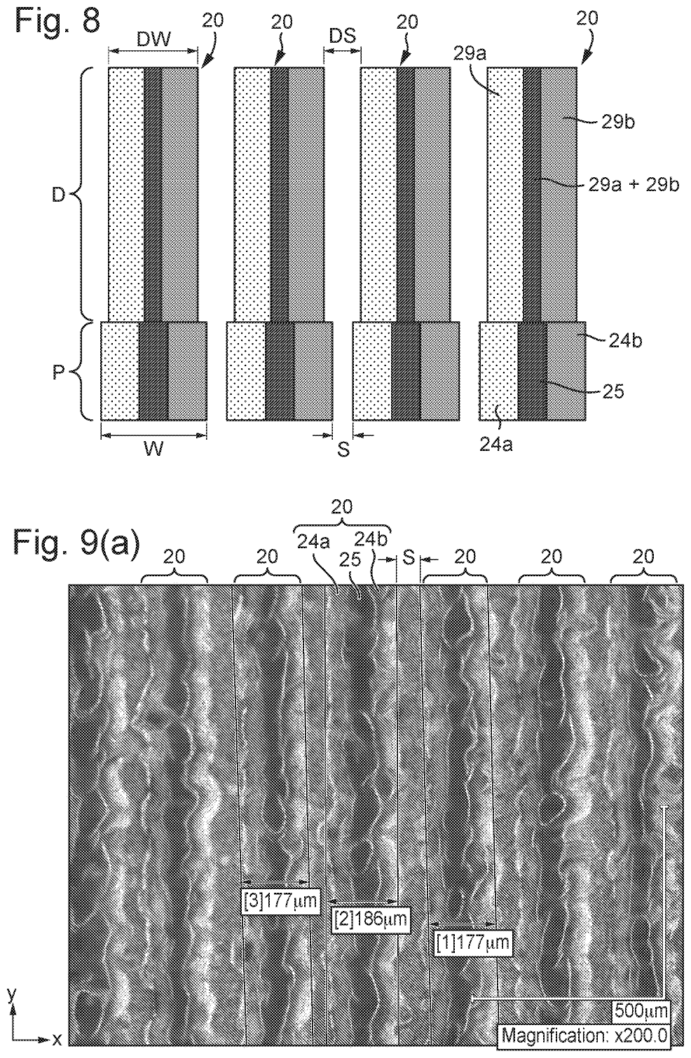

FIG. 8 schematically shows an array of printed elements forming part of a security device in accordance with an embodiment of the present invention, in plan view;

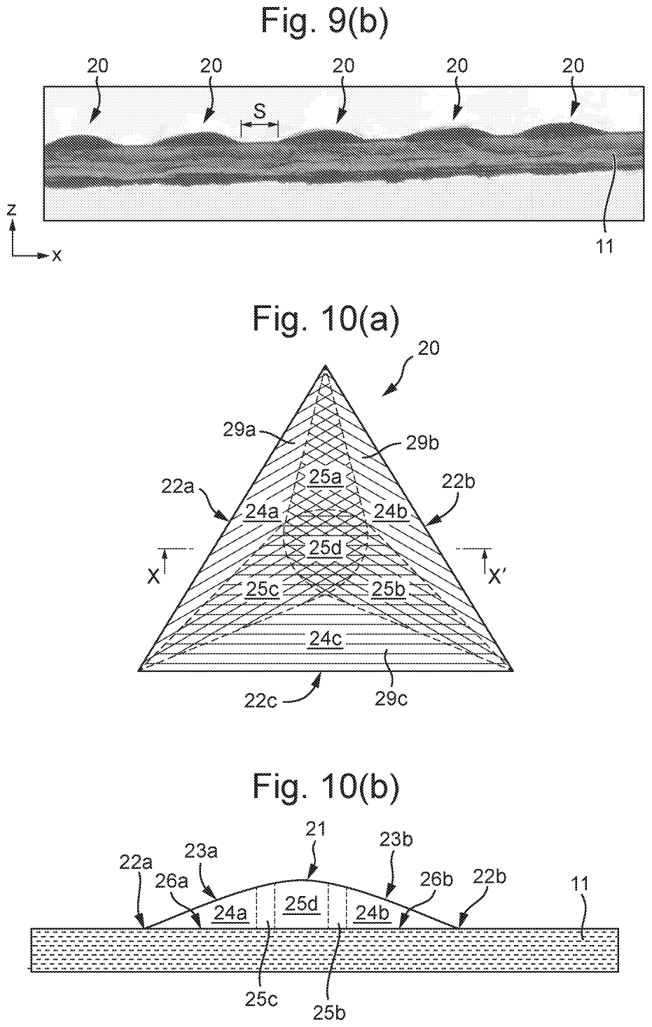

FIGS. 9(a) and (b) are photographs showing an exemplary array of printed elements forming part of a security device in accordance with an embodiment of the invention, in plan view and cross-section respectively;

FIG. 10(a) shows an alternative printed element forming a part of security device in accordance with another embodiment of the invention in plan view, and FIG. 10(b) shows a cross-section along the line X-X′ thereof;

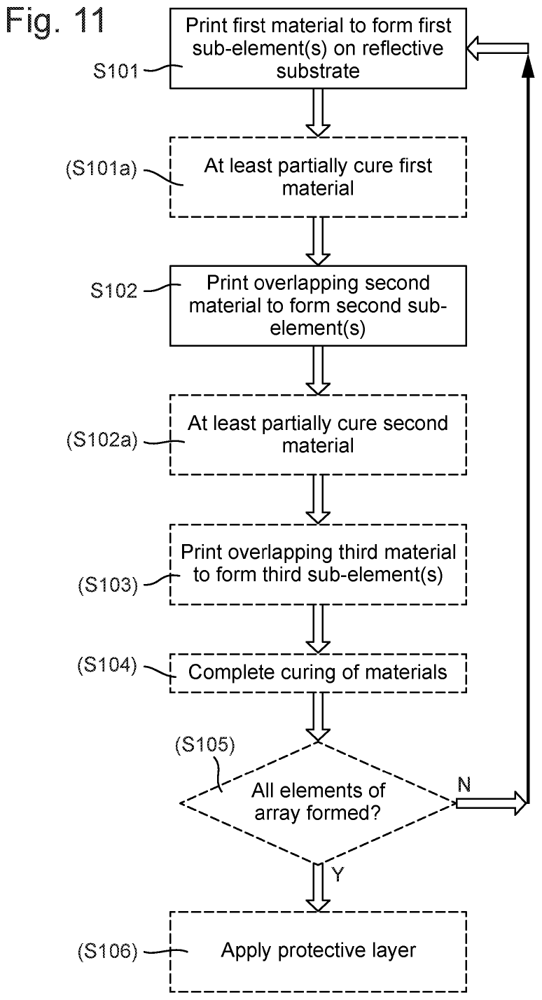

FIG. 11 is a flow chart showing exemplary steps in a method of manufacturing a security device in accordance with embodiments of the invention;

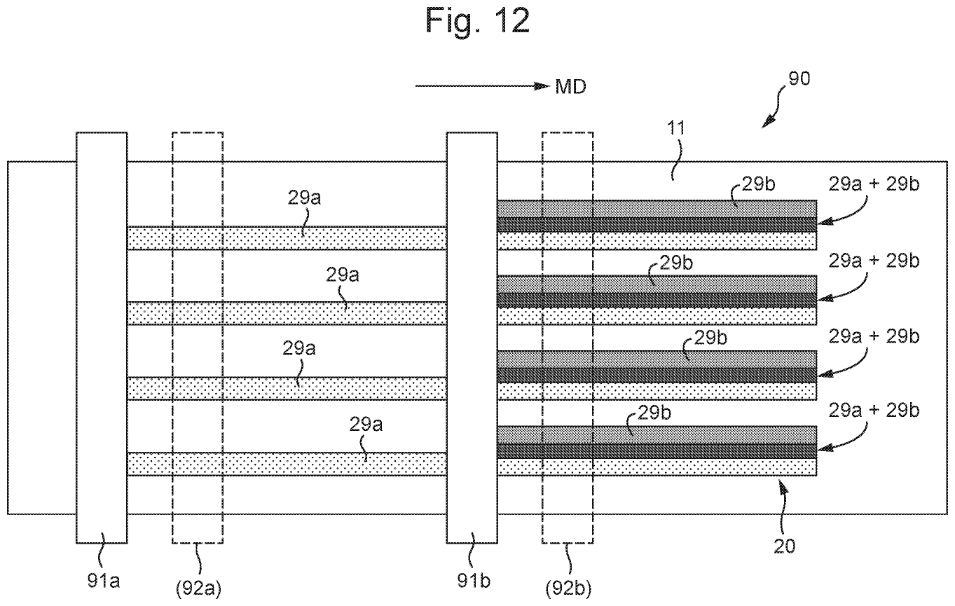

FIG. 12 schematically depicts an exemplary apparatus for manufacturing a security device in accordance with embodiments of the invention;

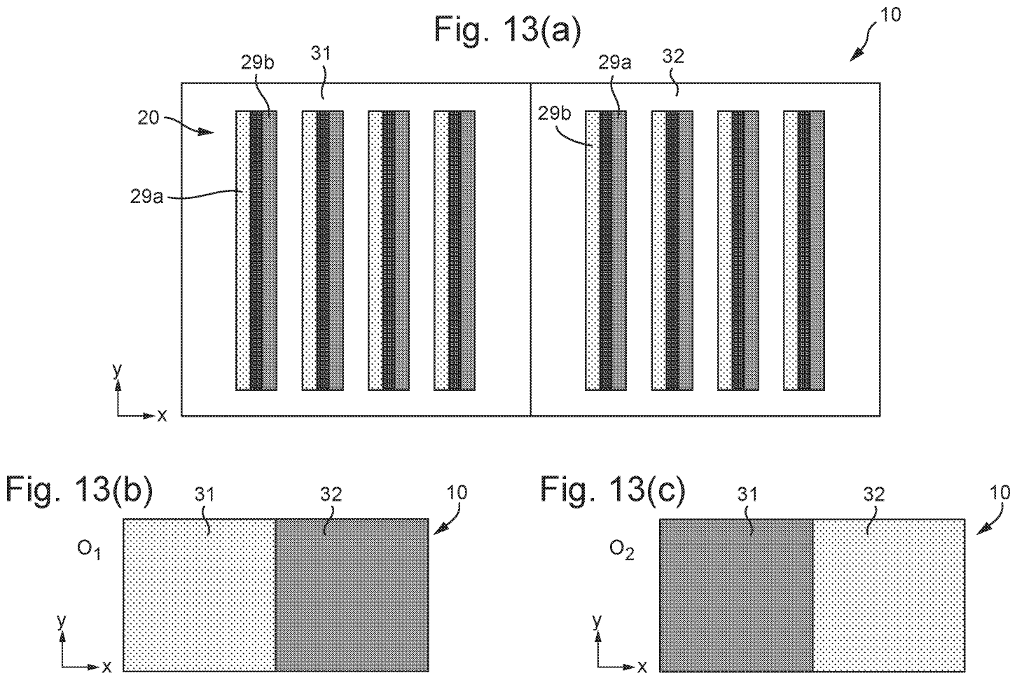

FIG. 13(a) schematically illustrates a security device in accordance with an embodiment of the invention, in enlarged plan view, while FIGS. 13(b) and (c) show the security device of FIG. 13(a) at lower magnification, from two different viewing angles;

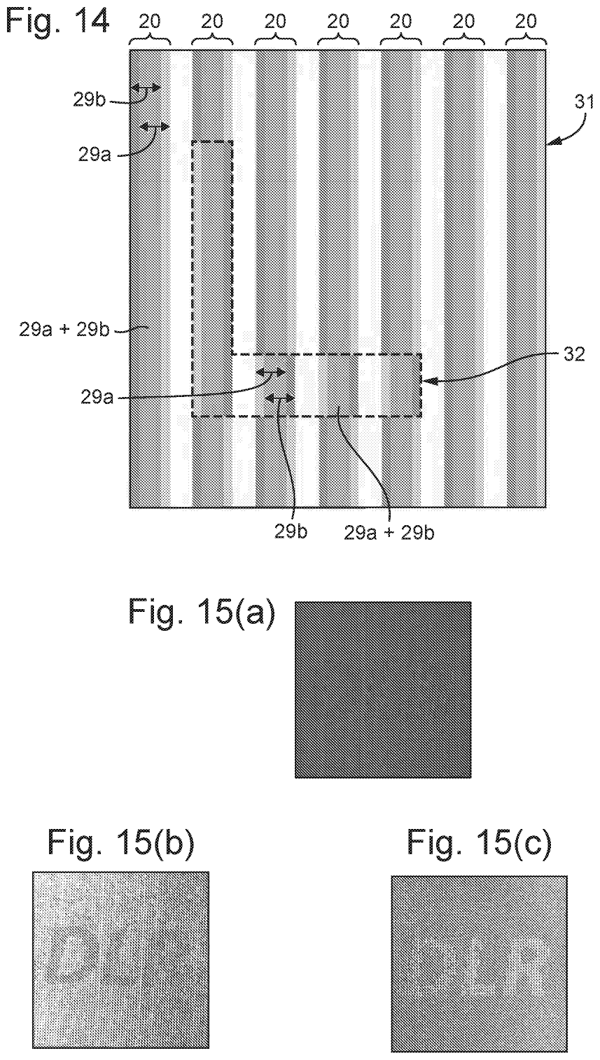

FIG. 14 schematically illustrates a portion of a security device in accordance with another embodiment of the invention, in enlarged plan view;

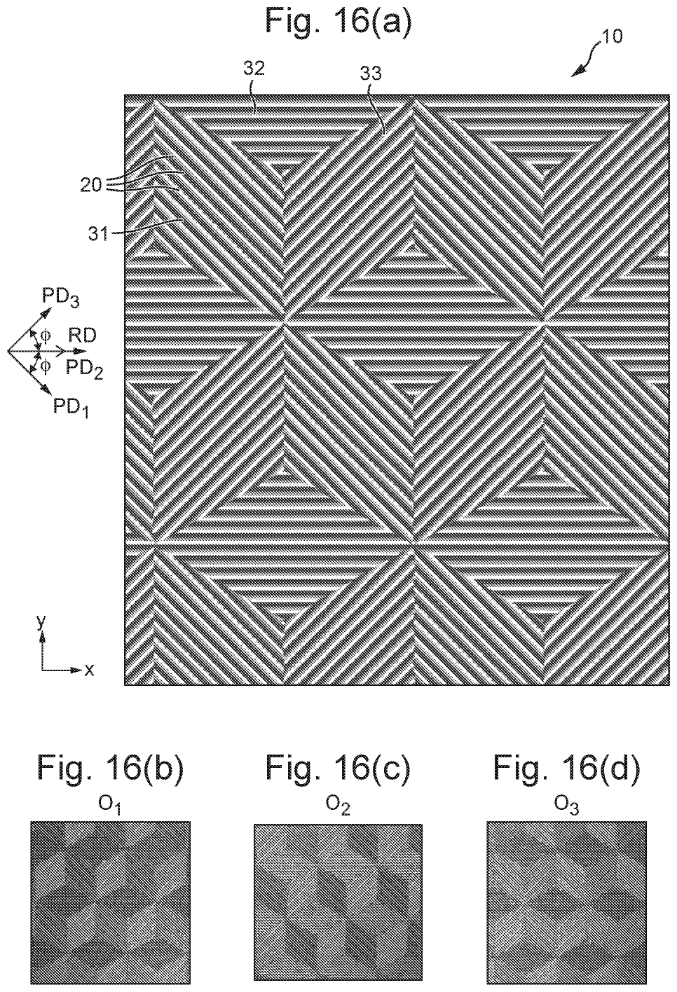

FIGS. 15(a), (b) and (c) are photographs showing the security device of which FIG. 14 illustrates a portion, (a) under diffuse lighting, and (b), (c) under directional illumination, from two different viewing angles;

FIG. 16(a) schematically depicts an embodiment of a security device, in enlarged plan view, and FIGS. 16(b), (c) and (d) are photographs showing the security device of FIG. 16(a) at lower magnification, under directional illumination, from three different viewing angles;

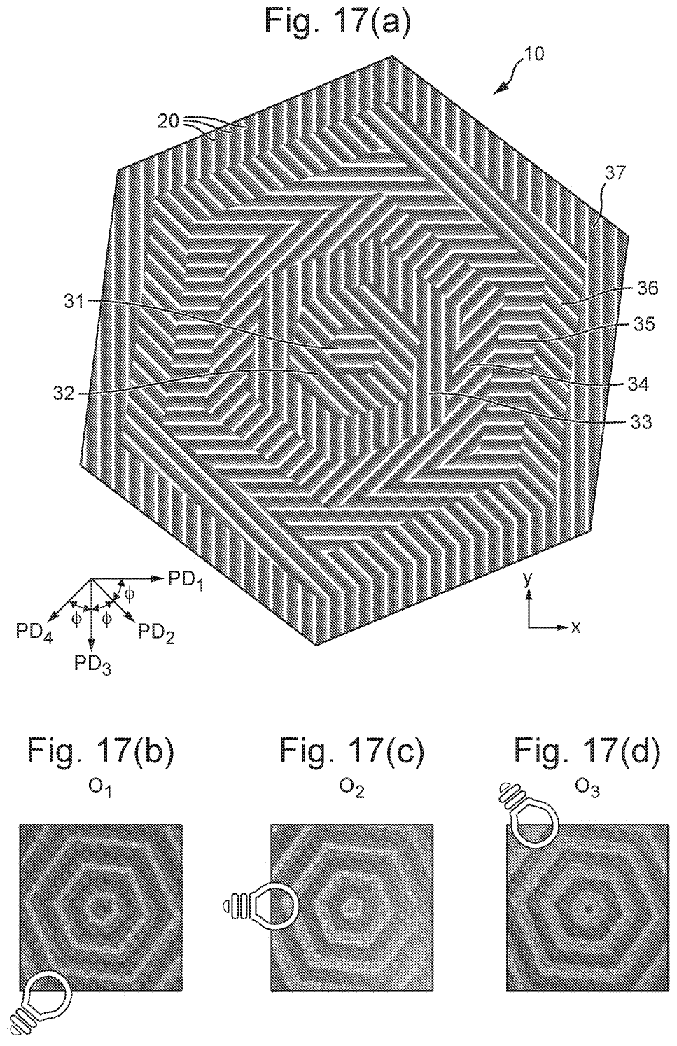

FIG. 17(a) schematically depicts another embodiment of a security device, in enlarged plan view, and FIGS. 17(b), (c) and (d) are photographs of the security device of FIG. 17(a), under directional illumination, from three different viewing angles;

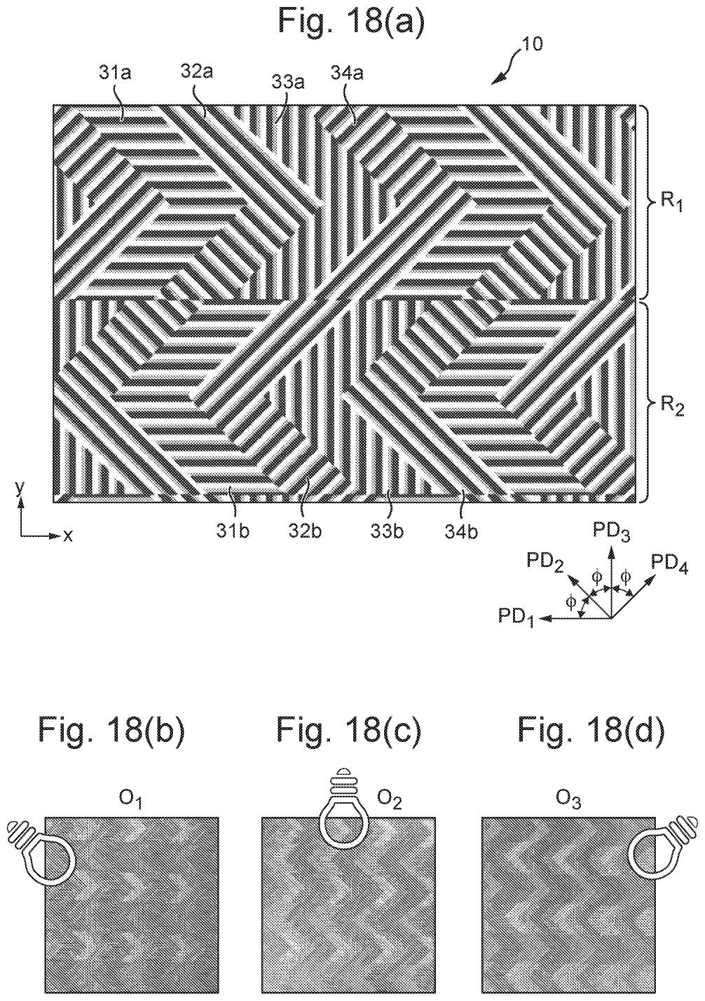

FIG. 18(a) schematically depicts another embodiment of a security device, in enlarged plan view, and FIGS. 18(b), (c) and (d) are photographs of the security device of FIG. 18(a), under directional illumination, from three different viewing angles;

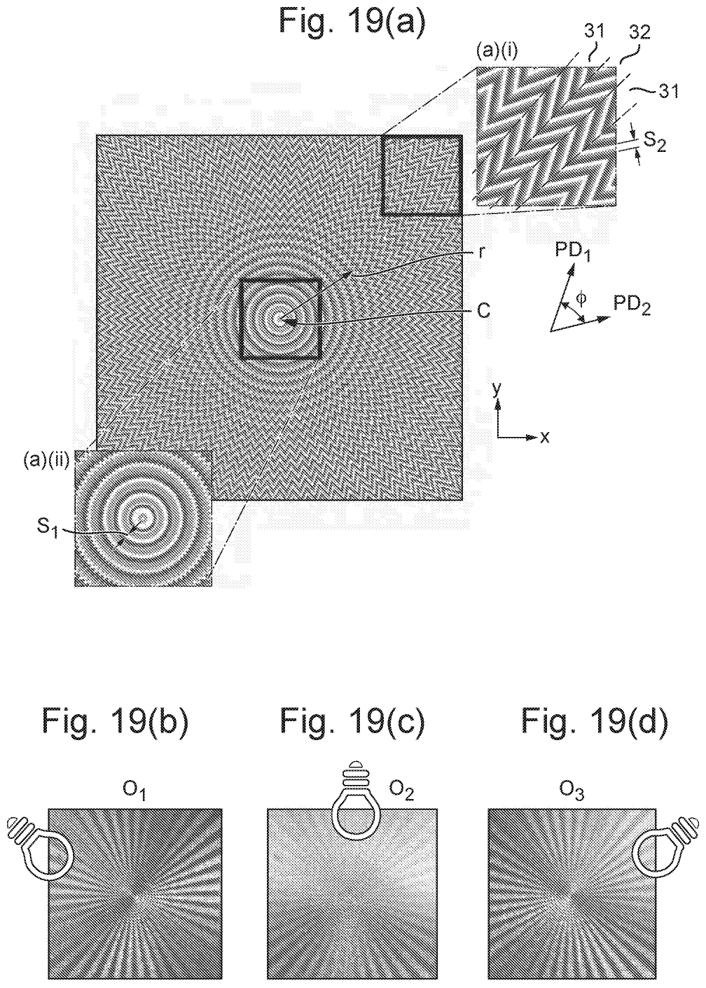

FIG. 19(a) schematically depicts another embodiment of a security device in enlarged plan view, FIG. 19(a)(i) and (a)(ii) showing further enlarged details thereof, and FIGS. 19(b), (c) and (d) are photographs showing the security device of FIG. 19(a) under directional illumination, from three different viewing angles;

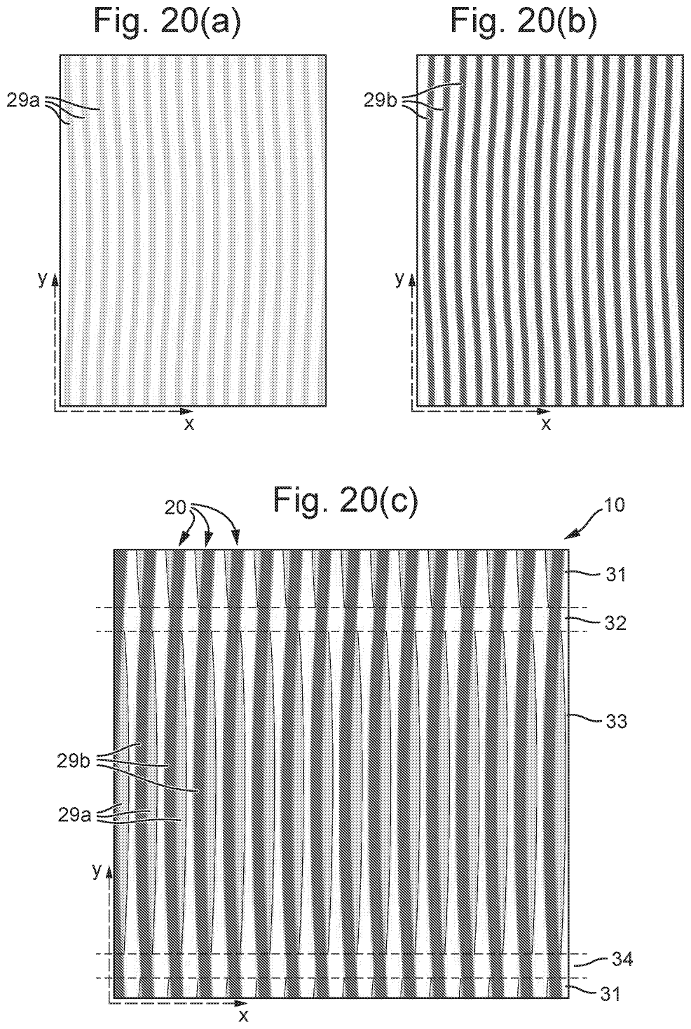

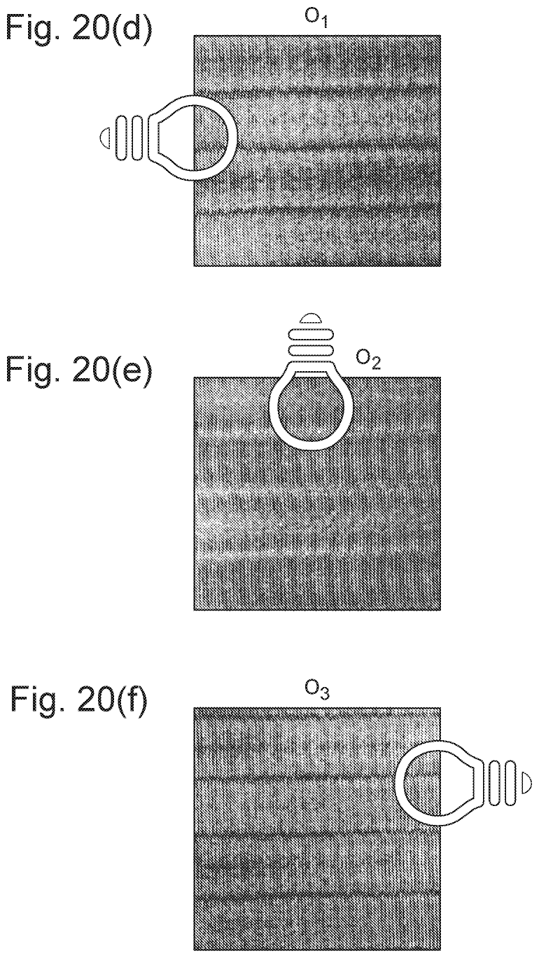

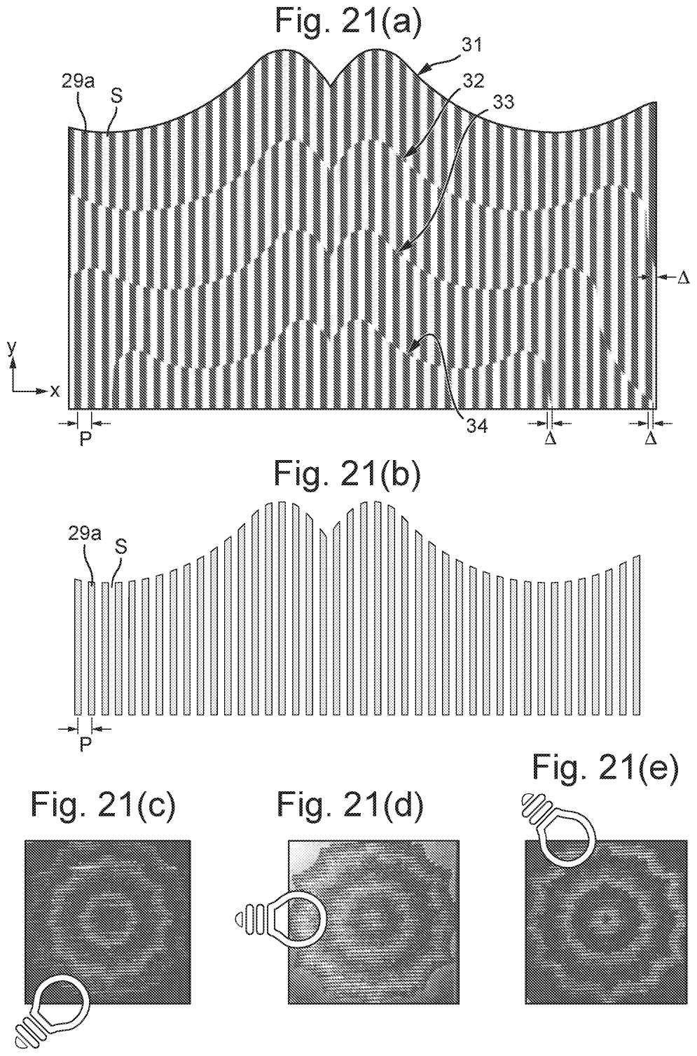

FIGS. 20(a) and (b) respectively schematically show first sub-elements formed of a first material and second sub-elements formed of a second material, FIG. 20(c) showing the combination of the first and second sub-elements to form another embodiment of a security device in accordance with an embodiment of the invention, in enlarged plan view, and FIGS. 20(d), (e) and (f) are photographs showing the security device of FIG. 20(c) under directional illumination, from three different viewing angles;

FIGS. 21(a) and (b) show first sub-elements formed of first and second sub-elements formed of a second material respectively, and FIGS. 21(c), (d) and (e) are photographs of a security device formed by the combination of the first and second sub-elements shown in FIGS. 21(a) and (b), under directional illumination, from three different viewing angles;

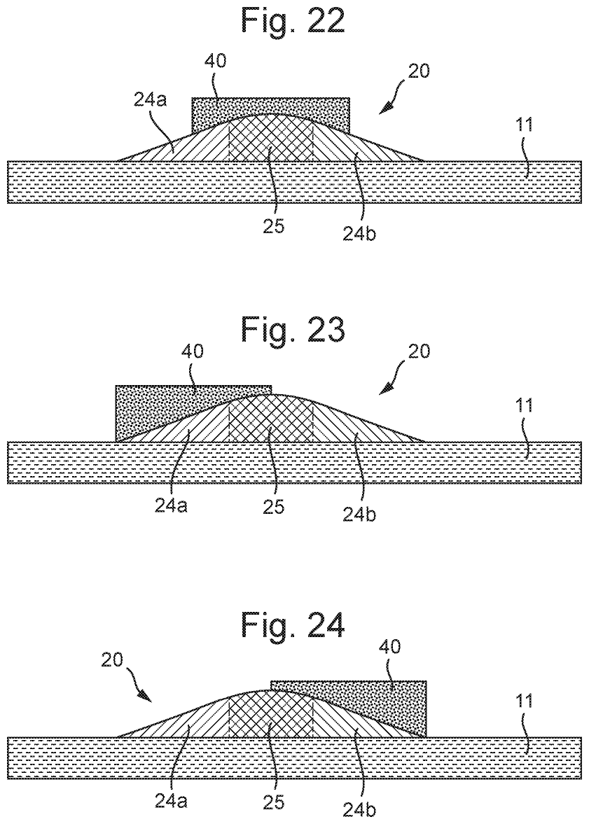

FIGS. 22, 23 and 24 show three further examples of printed elements forming part of security devices in accordance with embodiments of the invention;

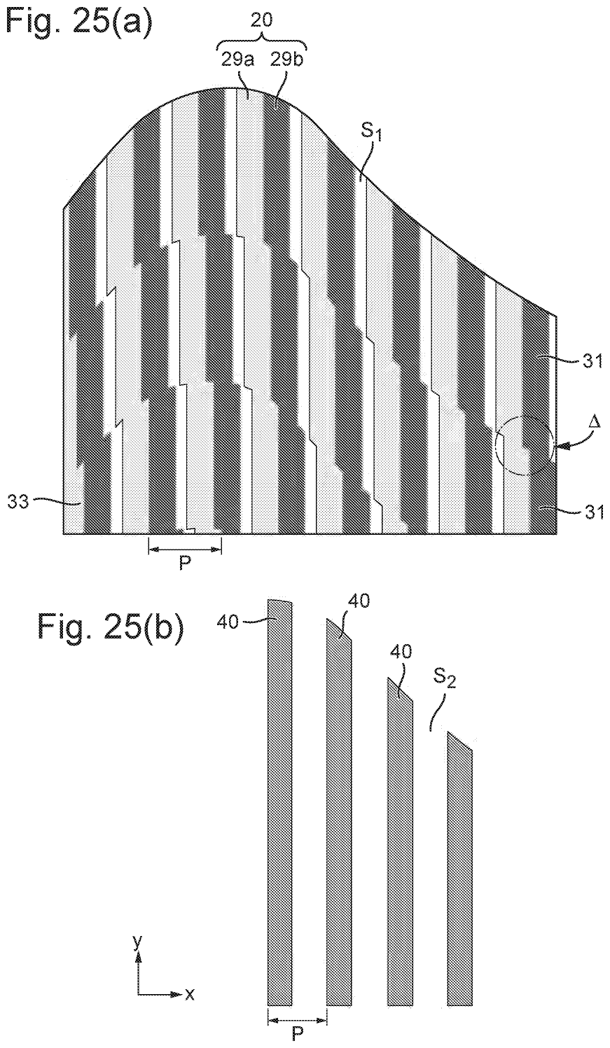

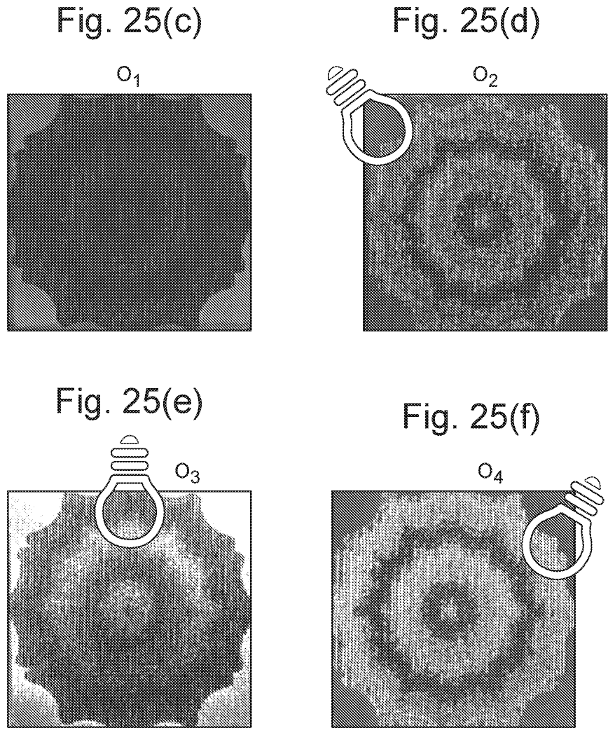

FIG. 25(a) shows a portion of an exemplary array of printed elements forming part of a security device in accordance with an embodiment of the invention, in enlarged plan view, and FIG. 25(b) shows a corresponding array of overlay elements; FIGS. 25(c), d), (e) and (f) are photographs of a security device in accordance with another embodiment of the invention, formed by the combination of the printed elements of FIG. 25(a) and the overlay elements of FIG. 25(b), (c) under diffuse lighting, and (d), (e), (f) under directional illumination, from three different viewing angles;

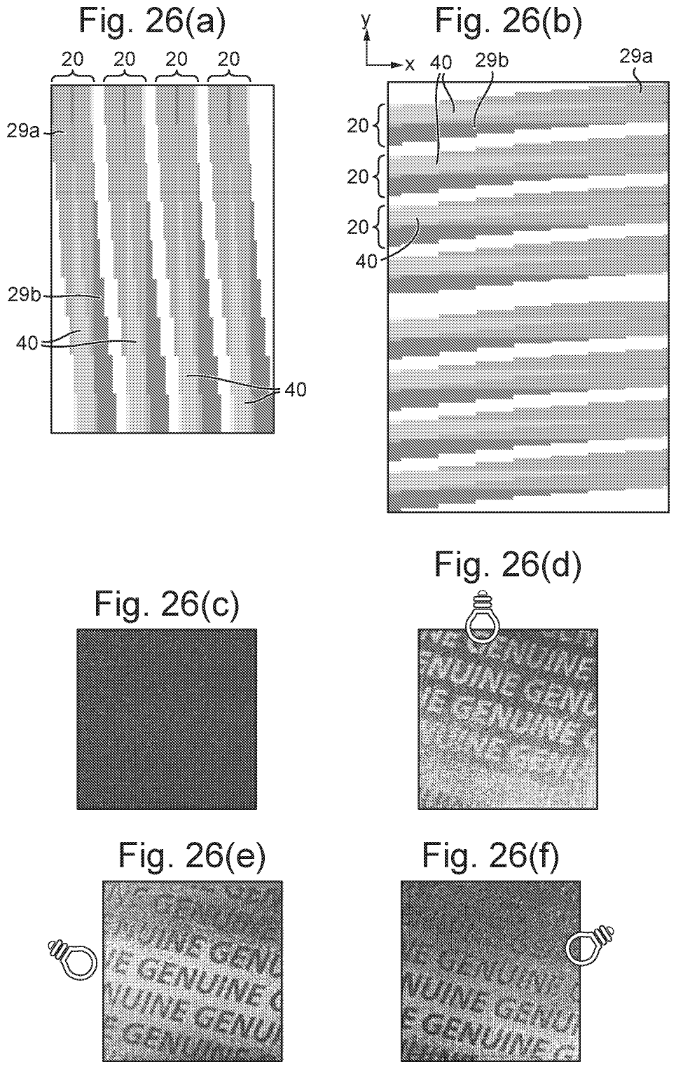

FIGS. 26(a) and (b) show two portions of an exemplary array of printed elements forming part of a security device in accordance with an embodiment of the invention, in enlarged plan view, and FIGS. 26(c) to (f) are photographs of the security device, (c) under diffuse lighting, and (d), (e), (f) under directional illumination, from three different viewing angles;

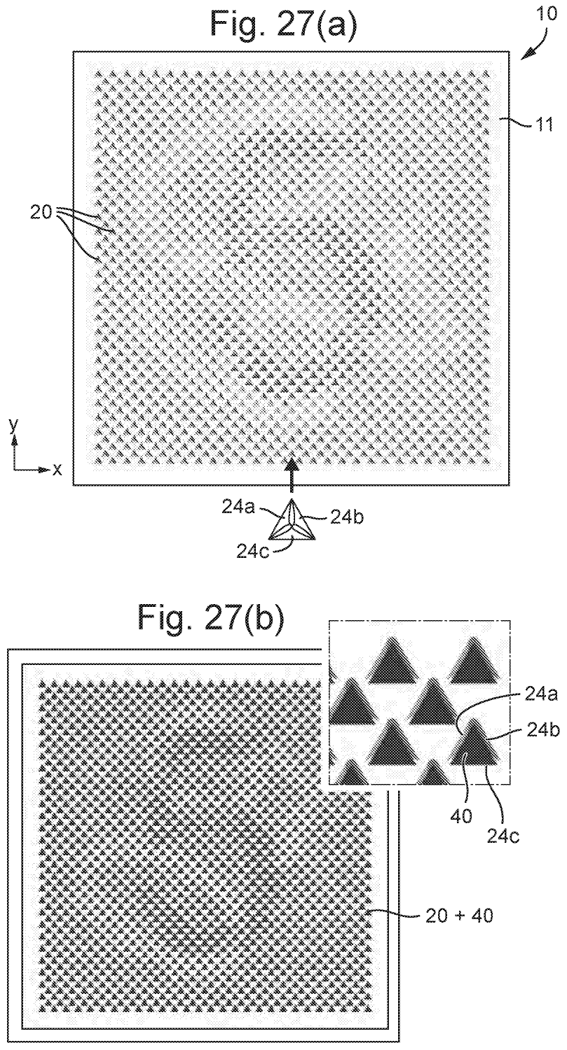

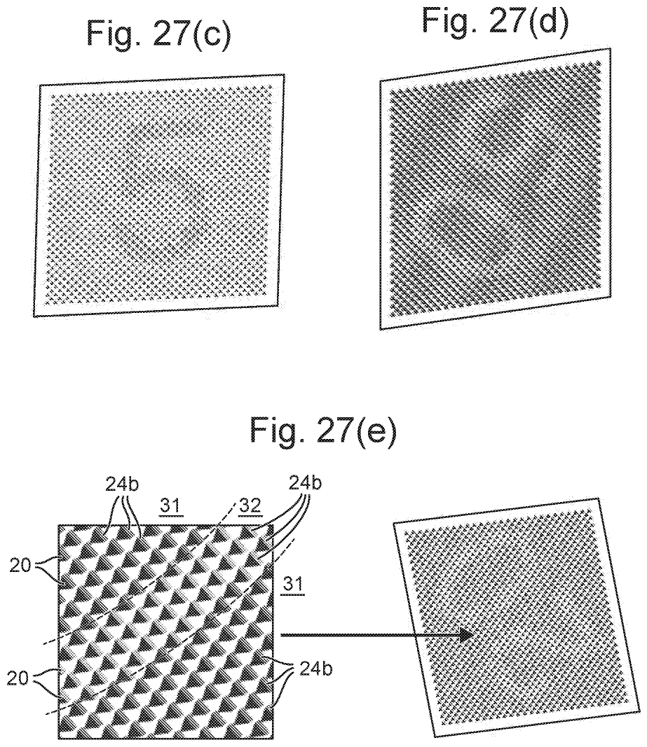

FIG. 27(a) depicts an array of printed elements forming part of a security device in accordance with another embodiment of the invention, one element thereof being shown in enlarged detail; FIG. 27(b) shows the array of printed elements of FIG. 27(a) with an additional array of overlay elements thereon, an enlarged detail of the composite elements being provided; and FIGS. 27(c), (d) and (e) depict the appearance of the security device from three different viewing angles, FIG. 27(e) including an enlarged detail thereof;

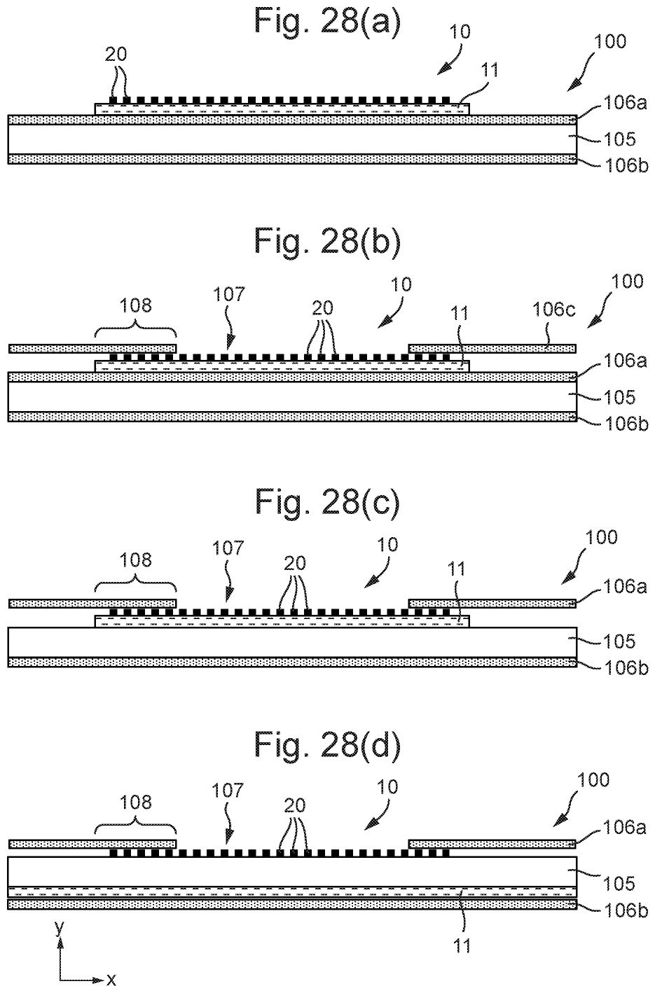

FIGS. 28(a), (b), (c) and (d) are cross-sections through four exemplary security documents provided with security devices in accordance with embodiments of the present invention;

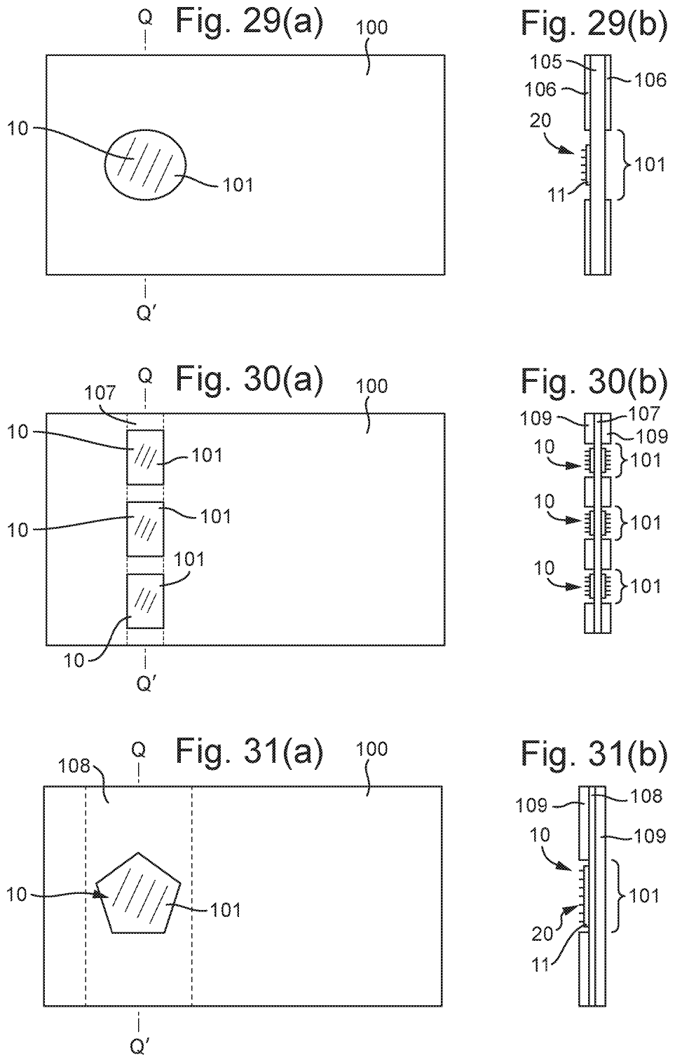

FIGS. 29, 30 and 31 show three exemplary articles carrying security devices in accordance with embodiments of the present invention (a) in plan view, and (b) in cross-section; and

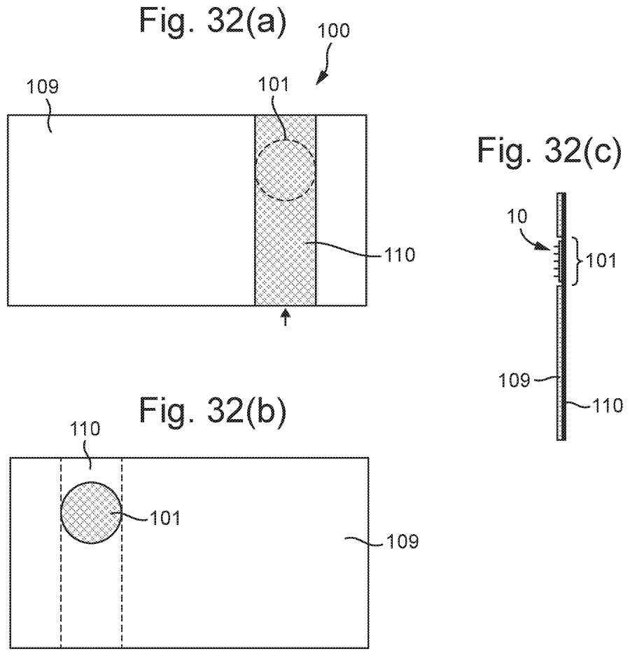

FIG. 32 illustrates a further embodiment of an article carrying a security device in accordance with the present invention, (a) in front view, (b) in back view and (c) in cross-section.

FIG. 1 shows an exemplary security document 100 in the form of a bank note. It will be appreciated that security devices 10 of the sort herein disclosed may be affixed to any object of value as a mark of authenticity, but are particularly suitable for use on security documents such as bank notes, passports, certificates, visas, credit cards and the like. As will be described in more detail below, the security device may be formed directly on the security document 100 or could be formed on a security article (such as a thread, strip, patch, foil etc) which is then affixed to or incorporated into the security document 100. FIG. 1 shows examples of each of these implementations. Security article 1 is shown here in the form of a security thread or strip affixed to a surface of the security document 100. The security article 1 is provided thereon with a security device 10′, shown schematically in FIG. 1, in accordance with any of the embodiments of the invention. The security document 100 of FIG. 1 also comprises a window region 101 which takes the form of a transparent area of the substrate, within which another security device 10″ in accordance with any of the embodiments the invention, is located. Here, the security device 10″ is formed directly on the substrate forming the security document 100.

In general, a security device 10 in accordance with embodiments of the invention comprises an array of printed elements 20 each of which has a raised surface profile relative to the substrate 11 on which they are formed, which remains flat. Two exemplary printed elements 20 which may be used to form such an array are shown in FIGS. 2(a) and (b), in perspective view. In all cases, each element will be formed of at least two materials having different optical characteristics (e.g. colour) from one another, which overlap in a portion of the element 20 (but not elsewhere). Referring first to FIG. 2(a), here the element 20 takes a form of a line element, which is depicted as rectilinear but could be curved, e.g. sinusoidal, or otherwise shaped. The line element 20 extends along the Y axis, and a cross-section through the elements along the perpendicular X axis is visible. It will be seen that the cross-sectional shape of the element 20 is a dome with a profile similar to that of a bell curve (i.e. a “normal” distribution).

The top 21 of the element 20 (i.e. that point on the surface of element 20 located furthest from substrate 11) is at the approximate centre of the element although this is not essential. From the top 21 of the element, a first side 23a slopes down to a first edge 22a of the element, and opposite, a second side 23b of the element slopes from the top 21 to a second edge 22b. The printed element 20 is formed of a first material 29a and a second material 29b. In a first edge portion 24a of the element, which includes first edge 22a and at least part of first side 23a, only the first material 29a is present. In a second edge portion 24b of the element, which defines second edge 22b and at least part of second side 23b, only second material 29b as present. Between the first edge portion 24a and second edge portion 24b is a middle portion 25 across which both the first material 29a and the second material 29b are present. In this region, the two materials may be mixed together (homogenously or otherwise) or may remain distinct from one another and overlap. Either way, both the first and second materials are present laterally throughout the middle portion 25, optionally to varying degrees.

It will be seen that the first and second materials form the flat base surface 26 of the element 20 (which makes direct or indirect contact with substrate 11, and is parallel to the plane of the substrate 11), and the upper surface (comprising first and second sides 23a, 23b and top 20), as well as the interior volume of the element 20. In the first edge portion 24a, the first material 29a forms both the flat base surface 26 and the first side 23a (and the intervening volume therebetween). In the second edge portion 24b, the second material 29b forms both the flat base surface 26 and the second side 23b (and the intervening volume therebetween). In the middle portion 25, the combination of first and second materials 29a, 29b forms the flat base surface and the top surface 21 of the element (and the intervening volume therebetween). The first and second materials, and particularly the fact they are combined across middle portion 25, give the element its three-dimensional shape.

Elongate elements such as that shown in FIG. 2 are suitable for use in many embodiments of the invention. However, in other cases, non-elongate element shapes such as dots, squares, triangles, circles, indicia etc., may be preferred.

This also provides each element with a greater number of edges and corresponding sides with different orientations from one another, leading to the possibility of forming each element 20 from a greater number of materials which can be used to increase the visual complexity of the device (and hence, ultimately, the security level). FIG. 2(b) shows an exemplary dot-shaped printed element circular in plan view, which again has a dome shaped cross-section and its top 21 in approximately the centre of the element 20. In this example, the element 20 is formed of four materials 29a, 29b, 29c and 29d each of which defines a corresponding side of the element 23a, 23b, 23c and 23d, each sloping from the top 21 to respective edges 22a, 22b, 22c and 22d. In a middle portion 25 of the elements, all four materials are present.

While the two examples of printed elements 20 shown in FIG. 2 have curved, dome-like profile shapes, which is preferred, this is not essential. Any profile shape having at least two sides sloping from the top of the element to respective edges of the element, could be used, provided that the sides have different orientations from one another and each lie at an acute angle to the substrate normal as measured at the respective edge of the element. The sides could be planar or curved. Hence other profile shapes which could be utilised include those with triangular or trapezium cross-sections. However, curved profiles (including domes, bell curves, arcuate and semi-circular cross-sections) are preferred since these can be achieved by printing alone without the need for casting or otherwise shaping the materials.

Typically, the top of each element 20 has a height h of at least 5 μm relative to the substrate, preferably at least 8 μm, more preferably at least 10 μm. Advantageously, the height h is also 50 μm or less, preferably 30 μm or less, still preferably less than 30 μm. Such heights provide a particularly good optically variable effect, and are achievable via the preferred manufacturing techniques disclosed below. The lateral width w of each element 20 is typically in the range to 500 μm, preferably 50 to 300 μm, more preferably 100 to 200 μm. Element widths in the above ranges have been found to produce a good visual effect whilst being achievable via a wide range of printing techniques. Generally it is desirable to keep the element width reasonably small (e.g. less than 200 μm) so that the elements are not individually discernible to the naked eye but rather the colour(s) presented by multiple elements are combined by the eye to give the appearance of an area of colour.

The amount of overlap between the first and second materials 29a, 29b (i.e. the extent of the middle portion 25) has a significant influence on the visual effect exhibited by the element, to be described below. Hence, preferably, in each element 20, the middle portion 25 occupies between 5% and 60% of the lateral area of the element (i.e. that seen in plan view), preferably between 10% and 50%, most preferably between 20% and 40%. Thus, for typical elements, the middle portion advantageously has a lateral width in the range 20 to 80 μm, preferably 30 to 50 μm. As shown in the present examples, the first and second edge portions 24a, 24b desirably occupy approximately equal proportions of the lateral area of the element as one another.

The substrate 11 on which the printed elements 20 are formed is a reflective substrate of which more details will be provided below. At least one of the materials used to form the element 20 is at least semi-transparent, i.e. optically clear and with low optical scatter. It is preferable that all of the materials used to form the elements are at least semi-transparent, but this is not essential and an example in which one of the materials is opaque will be given below. The various materials forming each element 20 have different optical characteristics from one another. For example, the first and second materials 29a and 29b may each have a visible colour which is different from one another. Alternatively, the first material 29a may have a visible colour whilst the second material 29b may be visually colourless. In still further examples, the different optical characteristic may be revealed under certain illumination conditions only, such as UV irradiation. Further examples will be given below. In the embodiments which follow, for the sake of clarity, it will be assumed that the at least two materials have different visible colours from one another, but it should be appreciated that in practice their optical characteristics might differ from one another in some other way.

FIG. 3 shows a cross-section through a printed element 20, which could be that shown in FIG. 2(a) or FIG. 2(b) for instance, along the line Q-Q′ indicated therein. The element 20 is disposed on reflective substrate 11, and as previously described comprises a first edge portion 24a formed of a first material 29a, a second edge portion 24b formed of a second material 29b and a middle portion in which both materials are present. The base surface 26 is flat and parallel to the plane of the substrate. When illuminated by a light from a light source L along a direction away from the substrate normal (indicated by light rays I in FIGS. 3 and 4), the element 20 exhibits a colourshift effect. That is, its appearance changes with viewing angle. The mechanism which enables this is shown most clearly in FIGS. 4(a) and 4(b), for the scenario in which both materials 29a and 29b are at least semi-transparent. As shown in FIG. 4(a), incident light I on the first edge portion 24a of element 20 first strikes side 23a of the element, at which point it is refracted and passes through the at least semi-transparent first material 29a and the portion 26a of base surface 26 in the first edge portion 24a before being reflected by substrate 11. The reflected light returns to the interior surface of first side 23a where it is refracted once again, away from the normal, along light ray R₁. As shown in FIG. 3, a first observer O₁ at a first viewing position to which light ray R₁ is directed will perceive the element 20 as having optical characteristics determined by the first material 29a.

As shown in FIG. 4(b), incident light I striking the second edge portion 24b of the element 20 will be refracted at second side 23b, pass through the second material 29b and the portion 26b of base surface 26 in the second edge portion 24b to the substrate 11 where it is reflected and returned to the inner surface of second side 23b. The reflected light is refracted along light ray R₂ towards a second viewing position. As shown in FIG. 3, a second observer O₂ located at that position will perceive the element to have optical characteristics determined by the second material 29b. Thus, as the viewing position is changed between that of observer O₁ and that of observer O₂, the element 20 will appear to undergo a change in appearance, from a first appearance dictated by first material 29a to second, different appearance dictated by material 29b. It should be appreciated that at other viewing angles, other appearances of the element may also be visible, such as a mixed colour intermediate between those of the first and second materials which may be visible at the normal viewing position.

As illustrated in FIG. 3, when both of the first and second materials 29a and 29b are at least semi-transparent, the effect of the geometry is such that the first appearance, corresponding to first material 29a, is visible at a viewing position on the opposite side of the element from the first edge portion 24a (observer O₁), while the second appearance of the element, seen by observer O₂, is visible at a viewing angle closer to the substrate normal. This is an unexpected reversal of the colourshift effect as compared with conventional colourshifting structures, in which the colour imposed by each material would be observed on the same side of the element as the respective material.

It will be appreciated that the positions at which each appearance can be viewed (and hence the angular range over which the colourshift effect is exhibited) will depend significantly on the orientation of each of the first and second sides 23a, 23b of the element, and particularly the angle(s) at which they lie relative to the substrate 11. In preferred embodiments, the first and second sides 23a, 23b of the element 20 each lie at an angle θ (measured for convenience between the side and the substrate normal) which is greater than or equal to 60 degrees and less than 90 degrees. The angle θ is measured at the respective edge of the element, although if the element side is curved, the angle it makes with the substrate normal will vary between the element edge and the element top. Slope angles of this magnitude have been found to give good results, with the two different appearances of the element being visible at adequately separated positions (so that the colour change can be viewed gradually rather than instantaneously) but without requiring an unduly large tilt of the device. More preferably, the angle θ is greater than or equal to 70 degrees and less than or equal to 85 degrees, which is found to give particularly good effects. It should be noted that while symmetrical element shapes are preferred, this is not essential so each side 23 could have a different slope angle θ (although advantageously each will be in one of the ranges identified above as preferable).

As already mentioned, the substrate 11 on which the printed elements 20 are formed is a reflective substrate, which could be substantially opaque, semi-opaque or transparent. This could take the form of a self-supporting film or foil of a reflective material, such as metal or a metal alloy, or a polymeric film with a glossy surface, which may or may not be transparent. However, in many cases the substrate 11 may take the form of a multi-layer structure and examples are shown in FIGS. 5(a) and (b). Typically, the substrate 11 may include a supportive carrier layer 11b preferably formed of paper or a plastic material such as BOPP, polyethylene, polycarbonate, PET, PVC or similar, and a reflective layer 11a applied to a surface thereof. In such cases the reflective layer 11a is preferably substantially opaque or at least semi-opaque. The reflective layer 11a is preferably specularly reflective and may be formed for example of a layer of metal or metal alloy, a metallic ink or other reflective ink, or a thin film interference structure. If the reflective layer 11a comprises a metal or metal alloy layer, it is preferably applied by vapour deposition in order to achieve a good level of specular reflection. If the reflective layer 11a comprises a metallic or other reflective ink, it may be applied via any available printing or coating method, or by transfer from another substrate.

If the carrier 11b is transparent, the printed elements 20, of which only one is schematically depicted in FIGS. 5(a) and 5(b), can be applied to either side of the multi-layer substrate 11. For instance, FIG. 5(a) shows the elements 20 having been printed directly on the reflective layer 11a of substrate 11, such as a metal layer, whereas FIG. 5(b) shows the element 20 printed on the opposite side of the carrier layer 11b from reflective layer 11a. In the arrangement shown in FIG. 5(a) it may be necessary to apply a primer layer (not shown) over reflective layer 11a before printing element 20, in order to improve the ink adhesion. In the case of the arrangement shown in FIG. 5(b), the carrier layer 11b would typically be corona treated before printing of elements 20 takes place, again to improve ink adhesion. Particularly preferred layer combinations include a bank note substrate comprising BOPP as carrier layer 11b and metallic ink applied to a surface thereof to form reflective layer 11a. In another example, a metallised PET foil could be used in which the carrier layer 11b is PET and the reflective layer is formed by a vapour deposited metal coating thereon. Where the reflective layer 11a is formed by a metallic or otherwise reflective ink, it is generally preferable to apply the elements 20 to the opposite side of the substrate 11 as shown in FIG. 5(b), so that the surface of the metallic ink presented to the viewer is flatter and hence more specularly reflective. However, if the base carrier 11b can be made sufficiently smooth, this may not be required and the arrangement shown in FIG. 5(a) can be used instead.

It will be appreciated that the reflectively layer 11a can be omitted if the carrier 11b has a sufficiently glossy surface to act as the reflective surface itself. In such cases, not all of the incident light will be reflected through the printed elements 20 (since some will be transmitted through the substrate) but there will be some specular reflection and so the optically variable effect disclosed herein will be exhibited, albeit in a weaker form. This will also be the case where the reflective layer 11a is only semi-opaque (e.g. a thin, semi-transparent metal layer).

The substrate 11 will be substantially flat (i.e. planar) at least where the elements are provided—that is, the substrate is not embossed or otherwise provided with a surface relief (except that formed by the elements 20) in the area supporting the elements 20. The elements 20 may be disposed directly on the substrate such that the first and second materials make direct contact with the substrate 11. Alternatively, one or more intervening layers (such as a primer) may exist between the elements 20 and the substrate 11. However any such layers will also be flat (i.e. of uniform thickness) and not introduce any surface relief in the region of the elements 20.

It should be noted that while the reflective layer 11a is flat relative to the elements in some embodiments it could nonetheless be provided with a diffractive relief structure, e.g. embossed into the layer. Diffractive relief profiles are of many orders of magnitude smaller than the dimensions of the printed elements 20 and so, at the macroscale, the reflective layer 11a remains flat relative to the elements. In such examples, the light reflected by layer 11a will also be diffracted by the structure, with the result that the colourshifting effect described above will appear superimposed on the diffractive image (e.g. hologram) imparted by the relief.

Whilst the colourshift mechanism has been described so far with respect to a single printed element 20, it will be appreciated that an array of identical elements of the sort already described will produce the same colourshift effect over the whole area in which the array is present. This is depicted in FIG. 6, which shows a cross-section through a plurality of elements 20 each as already described with reference to FIGS. 3 and 4. Thus from the position of first observer O₁, the whole area depicted will exhibit the first appearance, corresponding to that of first material 29a, whereas from the position of second observer O₂ the whole area will exhibit the second appearance, corresponding to that of second material 29b. The width w and spacing s of the elements 20 is preferably arranged to be sufficiently small such that, to the naked eye, the individual elements 20 cannot be discerned and the whole area appears substantially uniform at any one viewing angle. As the viewing angle is changed from the position of first observer O₁ to that of second observer O₂ (e.g. by tilting or rotating the device 10), the whole area undergoes a uniform colourshift from the first appearance, towards the second appearance dictated by second material 29b.

As mentioned above, it is not essential for all of the materials making up printed element 20 to be at least semi-transparent, and FIG. 7 shows an alternative example of an element 20 in another embodiment of a security device, in which the first material, located in first edge portion 24a, is semi-transparent but the second material, located in the second edge portion 24b, is opaque. Again, there is a middle portion 25 in which both the first and second materials are present. As shown in FIG. 7, incident light on first edge portion 24a will be reflected by reflective substrate 11 through the first material in the same way as described in the preceding embodiments. However, incident light I striking second edge portion 24b will be reflected by the second side 23b of the element 20 rather than by the reflective surface 11. This has the effect that the direction R₂ along which the light will be reflected differs from that in the first embodiment and hence the colourshift effect no longer appears reversed relative to the arrangement of materials. In general, the visual effect of elements with only one semi-transparent material (such as this) is weaker than those in which two are provided and the colourshift appears as a “glow” which the elements exhibits only at certain viewing angles, while appearing static at others.

As will be described in more detail below, the elements 20 are formed by printing, preferably ink jet printing, and thus the first and second materials 29a, 29b are typically inks, preferably ink jet inks. Examples of suitable formulations will be given below. Due to the nature of printing processes and the tendency of ink to spread on a substrate, the dimensions of the elements in the finished product will typically be different from those in the designed artwork. For comparison, FIG. 8 shows a plan view of a plurality of elements 20 shown at their design dimensions in region D and at their actual printed dimensions in the region P. It will be seen that the design width DW of each element is smaller than the width w of the element in the finished product. In addition, the proportion of the element 20 occupied by middle portion 25 may be greater than that in the design. The amount of ink spreading will depend on factors including the viscosity of the materials 29a and 29b, the material of the substrate 11 on which the elements 20 are printed and potentially other process parameters such as temperature. The skilled person will be able to take such factors into account and select suitable design dimensions in order to arrive at a desired final printed width w and spacing s, as well as the required proportion of overlap to arrive at a middle region 25 occupying the desired proportion of the element 20.

FIG. 9 shows high-magnification photographs of an exemplary security device of the same design shown in FIG. 8, (a) in plan view and (b) in cross section. It will be seen that each element 20 has a central dark region corresponding to middle portion 25 which is flanked by first edge portion 24a of a first material and second edge portion 24b of a second material. The elements 20 are spaced from one another from a distance s between adjacent edges of the respective elements. It should be noted that it is not essential for the elements 20 to be spaced, and in other embodiments adjacent elements could abut one another at their respective edges. However it is necessary to ensure that the relief shape (e.g. dome) of each individual element 20 remains intact. By reducing or omitting the spacing s between elements, the overall colour density exhibited by a region of the security device is increased, due to increased ink coverage. In the example shown, the finished elements 20 have a width w of around 180 microns and are spaced from one another by approximately 60 microns (s).

As mentioned above, alternative element shapes can be used including non-elongate elements such as dot elements, square elements, triangular elements or any other indicia such as letters or symbols. FIG. 10 shows an example of an element 20 having a triangular lateral shape and being formed of three different materials. A plan view of the element is shown in FIG. 10(a) and a cross-section through the element along the line X-X′ in FIG. 10(b). Again, the element has a dome-like profile in cross-section. Due to the triangular nature of the element 20, there are now three edges 22a, 22b and 22c and three respective sides 23a, 23b and 23c sloping from the top 21 of the element to the edges thereof. The element is formed of three materials 29a, 29b and 29c which overlap to varying degrees at the boundaries between them, as shown best in FIG. 10(a). Thus, a first edge portion 24a of the element consists of only a first material 29a, a second edge portion 24b consists only of a second material 29b and a third edge portion 24c of the element consists of only a third material 29c. In the centre of the element 20, all three materials 29a, 29b and 29c are present in a middle portion 25d. However, middle portions 25a, 25b and 25c are also present, each comprising only two of the three materials. For example, in region 25b, the second and third materials 29b and 29c are present, whilst in region 25c, the first and third materials 29a and 29c are present.

The incorporation of a third material 29c, which has a different optical characteristic from each of the first and second materials 29a and 29b, provides the element 20 with a third appearance which will be visible to the viewer at a third viewing position, different from those at which the first and second appearances of the element will be visible. The mechanism by which the light is redirected in the third edge portion 24c will be the same as those discussed above in relation to FIGS. 3 and 7, depending on whether the third material is at least semi-transparent or opaque, respectively. For all the reasons discussed above it is generally preferred that all three materials are at least semi-transparent.

Preferred methods and apparatus for forming security devices 10 of the sort disclosed herein will now be described as reference to the flow chart of FIG. 11 and the schematic apparatus shown in FIG. 12. In general, the method comprises steps of printing a first material to form a first sub-element on the reflective surface (step S101 in FIG. 11) and of printing an overlapping second material to form a second sub-element (step S102 in FIG. 11). The first sub-element is that part of element 20 in which the first material is ultimately present (e.g. first edge portion 24a plus middle region 25 in the FIG. 2(a) embodiment). The second sub-element is that part of the element 20 in which the second material is ultimately present (e.g. second edge portion 24b plus middle region 25 of the FIG. 2(a) embodiment). This results in an element 20 of the sort already described above. The remaining steps shown in FIG. 11 in dashed lines (described below) are preferred but non-essential.

It is possible to complete each individual element 20 before printing the next. That is, in step S101, a single first sub-element could be formed and in subsequent step S102 a single second sub-element could be formed to overlap it, before moving onto produce the next element 20. However, for speed and efficiency, it is generally preferred that multiple elements are formed simultaneously. Thus, in step S101, preferably a plurality of first sub-elements will be printed onto the reflective substrate and, in subsequent step S102, a corresponding plurality of second sub-elements will be printed, each one overlapping with one of the first sub-elements, resulting in a plurality of elements 20 arranged in an array as previously described. As such, all of the elements 20 may be formed in these two printing steps, in which case the repetition provided for in optional step S105 of FIG. 11 can be avoided.

FIG. 12 shows a reflective substrate 11 in the form of a web or a sheet being conveyed in the machine direction MD by a transport assembly (not shown) through a first print head 91a and subsequently a second print head 91b. The substrate 11 could comprise, for example, a polymeric substrate suitable for being formed into security articles such as labels (typically less than about 70 microns thick), a paper or polymeric substrate suitable for forming into documents, preferably security documents, (typically more than 70 microns thick), or some other substrate, such as cardboard, which may ultimately be formed into an object of value, such as packaging. It should be noted that whilst in this case the whole of substrate 11 is reflective, this is not essential and in other cases the substrate may only be reflective in one or more areas at which the security device(s) are to be formed. If the printed elements are to be applied on the same side of the substrate as the reflective layer, the reflective material could be applied to the selected areas of the substrate either in a separate earlier process, or upstream of the first and second print heads 91a, 91b in an inline process. If the printed elements 20 and reflective layer are to be on opposite sides of the substrate (which would have to be transparent in this case), they can be applied in either order, in one inline process or in two separate processes. The first print head 91a is configured to implement step S101 by printing the first material 29a onto the reflective substrate forming an array of first sub-elements. At the second print head 91b, step S102 is performed by printing second material 29b onto the substrate 11 forming an array of second sub-elements, each one overlapping a first sub-element of the first material 29a already present. The result is a set of elements 20 of the sort already described.

Any available printing technique could be used to lay down the first and second materials 29a, 29b, which are typically inks. However it is preferable to use a digital print technique, i.e. one in which the artwork is stored in software and no master printing plates are required. This enables the arrangement of the elements to be changed “on the fly” and thus the security device 10 can be personalised to a holder of the document if desired. Most preferably, the first and second materials 29a, 29b are printed by inkjet printing and the print heads 91a and 91b are inkjet print heads.

The first and second materials 29a and 29b could be physically drying inks (i.e. which become fixed by evaporation of a solvent contained therein), but more preferably are curable inks (i.e. those which become fixed due to cross-linking). This has been found to enable better control over the size and shape of the elements 20 and thus better colourshifting effects. The first and second materials 29a,b could be cured simultaneously in a final step after both have been printed. However, as shown in FIG. 11, optionally each material may be at least partially cured after it has been laid down and before the next is applied. Thus, in a preferred embodiment, after the first sub-elements have been printed onto the substrate in step S101, the first material 29a is at least partially cured and a curing station 92a is shown in FIG. 12 for this purpose (step S101a). The nature of the curing energy emitted by curing station 92a will depend on the type of curable material used but typically this will comprise heat and/or radiation, preferably UV radiation. At this stage the first material 29a need only be partially cured to the extent that its position is fixed, a process typically referred to as “pinning”.

The method then proceeds with the application of the second material 29b to form the overlapping second sub-elements at print head 91b (step S102). Next, the second material 29b is at least partially cured at a second curing station 92b (step S102a). Again, this may comprise UV irradiation. If only two materials are being used, this step will typically complete the cure of both the first and second materials. If a third or any subsequent materials are to be applied, corresponding print heads may be provided downstream, each if necessary with a neighbouring curing station to pin the material just laid down. Once all the materials have been laid down, in step S104, a final curing step may be carried out to complete the cure of any of the materials. Once all of the elements of the array have been formed, in optional step S106 a transparent protective layer such as a lacquer may be applied over the top of the array of elements 20 to protect the device from damage and soiling during handling.

A suitable ink jet printer which can be used to manufacture security devices as disclosed herein is the Mimaki UJF-6042, which is a scanning flatbed UV printer, equipped with piezo “drop on demand” ink jet heads. To produce samples of the devices, some of which are shown in photographs discussed below, the printer was set to 1200×1200 dpi resolution (variable droplet), with the press speed (“pass”) set to 16, and the printer operating in its “pure colours”, high-quality print mode. Another suitable apparatus is a sheet fed press with KM1800i heads (from Konica Minolta, Inc of Tokyo), for which the optimal printing settings were found to be 1200×600 dpi resolution, 1 dpd (drop per dot) and 1100 mm/s speed. Web fed presses can also be used.

The at-least semi-transparent materials (typically inks) each preferably have an optical density of less than 0.9, preferably less than 0.8, more preferably less than Optical density is a dimensionless ratio and is measured on a transmission densitometer, with an aperture area equivalent to that of a circle with a 1 mm diameter. A suitable transmission densitometer is the MacBeth 10932. Each material typically comprises pigments and/or dyes which impart its optical characteristics. The first and second materials 29a, 29b used to form each element 20 can differ in any optically-detectable way from one another, but preferably this is visible to the naked eye under at least some illumination conditions. For example, the first and second materials may each have a visible colour under normal white light illumination, which colours are different from one another. Alternatively, one of the materials may have such a colour while the other is colourless under white light illumination. Alternatively or additionally, the first and second materials may have different responses to one another other some other waveband of illumination such as UV illumination. For instance, one of the materials may luminesce in the visible spectrum when illuminated with an appropriate excitation wavelength while the other material may not (at the same illumination wavelength), or may respond differently (e.g. with a different colour luminescence and/or different intensity).

Examples of suitable materials include the following ink jet inks:

Cyan ink formulation (Mimaki UV LH-100 CYAN)
(Optical density 0.51)

| | |
|---|---|
| Hexamethylene diacrylate; | 30 to 50% w/w |
| Tetrahydrofurfuryl acrylate; | 20 to 30% w/w |
| Pentaerythritol triacrylate; | 20 to 30% w/w |
| 2-[[3-[(1-oxoallyl)oxy]-2,2-bis[[(1- | 10 to 20% w/w |
| oxoallyl)oxy]methyl]propoxy]methyl- | |
| 2-[[(1-oxoallyl)oxy]methyl]1,3- | |
| propanediyl diacrylate; | |
| 2-methyl-1-(4-methylthiophenyl)- | 10 to 20% w/w |
| 2-morpholinopropan-1-one; | |
| 4-hydroxy-2,2,6,6- | 1 to 5% w/w |
| tetramethylpiperidinoxyl. | |

Magenta ink formulation (Mimaki UV LH-100 MAGENTA)
(Optical density 0.61)

| | |
|---|---|
| Hexamethylene diacrylate; | 30 to 50% w/w |
| Tetrahydrofurfuryl acrylate; | 20 to 30% w/w |
| Pentaerythritol triacrylate; | 20 to 30% w/w |
| 2-methyl-1-(4-methylthiophenyl)- | 10 to 20% w/w |
| 2-morpholinopropan-1-one; | |
| 4-hydroxy-2,2,6,6- | 1 to 5% w/w |
| tetramethylpiperidinoxyl. | |

A suitable yellow ink formulation is also available from Mimaki (Mimaki UV LH-100 YELLOW) with an optical density of 0.06.

Further examples of suitable semi-transparent materials include “Luminescence ‘scratch resistant process magenta LED curing’ ink” (product code J42798U) and “Luminescence ‘scratch resistant process cyan LED curing’ ink” (product code J75369U), both supplied by Luminescence International Limited of Harlow, UK. These are visible magenta and cyan inks, respectively, which do not fluoresce under UV.

Examples of suitable materials which do luminesce under UV irradiation include “invisible fluor red LED curing” ink (product code J12421UF), “invisible fluor green LED curing” ink (product code J11939UF) and “invisible fluor blue LED curing” ink (product code J11938UF), all supplied by Luminescence International Limited.

These inks are visually colourless (clear) under standard (non-UV) illumination but luminesce at the indicated visible colours when irradiated with UV.

Several examples of security devices 10 comprising printed elements 20 of the sort described above will now be described with reference to FIGS. 13 to 21. In all of these examples, each printed element 20 is a line element formed of a first material 29a and a second material 29b, and the same materials are used to form each of the elements making up the array. That is, the first material 29a is the same in each of the elements of the array, and likewise, the second material 29b is the same in each of the elements of the array. As will be explained below, whilst this is preferred in many implementations, it is not essential and in other types of security device formed using the disclosed principles, the individual materials might vary from one element to the next.

FIG. 13 shows an example of a security device 10 having two regions 31 and 32 with an appearance that appears to switch upon tilting. In FIG. 13(a), the elements 20 within each region 31, 32 are shown schematically at an enlarged scale, so that their configurations can be clearly seen. All of the elements 20 in first region 31 have the same “first” configuration as one another, meaning that they are formed of the same two materials, in the same sequence, and are aligned along the same direction as one another, with the result that, upon tilting, the whole first region 31 will exhibit a uniform colourshift from the appearance of first material 29a to the appearance of second material 29b, in the same manner as already described above. In the second region 32, the elements 20 have a different “second” configuration from the elements in region 31, but again this is the same configuration for all of the elements in second region 32, with the result that the whole second region 32 exhibits a uniform colourshift upon tilting. Relative to the elements in region 31, in region 32 the sequence of the materials in each element is reversed, which is equivalent to the elements 20 in region 32 having a different orientation from those in region 31—namely, a rotation through 180 degrees. Since the same two materials 29a, 29b are used to form the elements in region 32 as those forming elements in region 20, the colourshift will be between the same two appearances. However, since the elements 20 in the second region 32 are arranged with their materials in reverse order as compared with those in first region 31, the colourshift effect will be the reverse of that seen in region 31.

To illustrate this, FIGS. 13(b) and (c) schematically depict the same security device 10 at a lower magnification at which the individual elements 20 cannot be discerned. Thus, each of the first and second regions 31, 32 appears to have a uniform colour at any one viewing angle. From the position of a first observer O₁, as shown in FIG. 13(b), the first region 31 exhibits a colour determined by first material 29a whilst simultaneously the second region 32 exhibits an appearance dictated by second material 29b. Upon tilting to a second viewing position at which observer O₂ is located, as shown in FIG. 13(c), the appearance of region 31 has changed to that dictated by second material 29b whilst that of region 32 now has the appearance of first material 29a. Thus, the appearance of the device appears to have switched. As an example, if the first material 29a is red and the second material 29b is blue, arranged on a silver-coloured reflective substrate 11, from the position of observer O₁ region 31 will appear red whilst region 32 appears blue, and from the position of observer O₂, the colours will appear to have switched such that region 31 appears blue whilst region 32 appears red.

Whilst for simplicity the security device 10 in FIG. 13 depicts only two regions of the same size and shape located adjacent one another, it will be appreciated that in practice any number of such regions could be provided, having any shape, size or position as necessary for the design of the device. In preferred embodiments, the contrast between the two or more regions (which will be visible at at least some viewing angles though not necessarily all) can be used to define an image, such as alphanumeric text, symbols, logos or the like. An example will now be described with reference to FIGS. 14 and 15.

FIG. 14 schematically shows an enlarged portion of a security device 10 which again is formed of two regions 31 and 32. Here, the first region 31 forms a background for a second region 32 which here has a form of the letter “L”. As in the previous embodiment, it will be seen that the elements 20 in the first and second regions 31, 32 have the same shape and direction as one another and are formed of the same first and second materials 29a, 29b. However, in second region 32, the order of the materials is reversed as compared with in the first region 31, such that the elements have the opposite orientation. That is, in the first region 31, each element 20 is arranged such that first material 29a is on the right edge of the element (as seen in the Figure), whilst second material 29b is on the left. In second region 32, this order is reversed with second material 29b on the right of each element 20 and first material 29a on the left. In both cases as before there is a middle region of the element where both materials are present.

Thus, all of the elements 20 in first region 31 have a same first configuration as one another, whilst all of the elements 20 in second region 32 have a same second configuration as one another. The result is much the same as that described with reference to FIG. 13, with both the first and second regions 31, 32 exhibiting a colour shift between the same two extremes upon tilting, but the colourshift being reversed in direction between the two regions. That is, at a first viewing angle, the background region 31 will exhibit the appearance of first material 29a (e.g. yellow) whilst simultaneously the second region 32, in the shape of the letter “T”, will exhibit the appearance of second material 29b (e.g. blue). Thus, the portion of the device will appear to exhibit a blue letter “L” against a yellow background. Upon tilting to a second viewing position, the image will appear to switch, with the first region 31 now exhibiting the appearance of second material 29b (e.g. blue) and the second region 32 now appearing the colour of first material 29a (e.g. yellow).

It will be apparent from an inspection of FIG. 14 that the two described regions 31, 32 have been formed by printing a set of first sub-elements of first material 29a and a set of second sub-elements of second material 29b. Each set of sub-elements comprises an array of rectilinear line elements extending along the y-axis and spaced from one another in the x-axis, with the same pitch in both set. The two sets are arranged to partially overlap. Each set of sub-elements has a discontinuity at the boundary between the first and second regions, such that in the second region 32 the sub-elements have been laterally offset in the X axis direction relative to their positions in the first region 31, but in opposite directions.

As shown in the Figure, the result is that in second region 32 the order of materials in each element 20 has been reversed relative to that in the first region 31, as already described.

Photographs of an exemplary security device formed according to the principle shown in FIG. 14 are provided in FIGS. 15(a), (b) and (c). In FIG. 15(a), the security device is seen in diffuse lighting and it will be seen that the device appears uniform and featureless. In FIGS. 15(b) and (c), the same device is shown under direct illumination from two different viewing angles (relative to the illumination direction). Both the first and second regions exhibit a colourshift effect, but the behaviour of the two regions differs with each one exhibiting its extremes of appearance at different viewing angles. At some viewing angles, the letters “DLR” (corresponding to the second region 32) become clearly apparent due to the contrast between the appearance of the first region 31 (the background) and that of second region 32 (the letters). The colours of the two regions appear to switch on tiling. Thus, at the viewing position corresponding to FIG. 15(b), the device exhibits blue letters “DLR” against a yellow background, and at the viewing position corresponding to FIG. 15(c), the colours have swapped and the device exhibits yellow letters “DLR” against a blue background. It will be appreciated that any colours or other differing optical characteristics could be substituted for the yellow and blue materials used as examples here.

Another exemplary security device is shown in FIG. 16. Here, FIG. 16(a) is an enlarged portion of the artwork based on which the device is printed. For simplicity, each element 20 is depicted as having just two portions, formed of a dark ink and a light ink respectively, but in reality these will overlap in a middle portion (not shown in FIG. 16(a)) as described above. Here, the security element comprises three distinct regions 31, 32, 33, each exhibiting a different behaviour upon tilting, which are repeated across the device 10 to make up the overall pattern. In this embodiment, what varies between regions is the pattern direction PD of the elements 20. Thus, in a first region 31, the array of line elements 20 is aligned along a first pattern direction PD₁, which is different from second pattern direction PD₂ in the second region 32, and different again from third pattern direction PD₃ in the third region 33. Taking the x-axis as a reference direction RD, the first and third pattern directions PD₁ and PD₃ make an angle 4) with the reference direction of −45 degrees and +45 degrees respectively. The second pattern direction is parallel with the reference direction. Thus the angular separation between each pattern direction in this example is equal, which is preferred but not essential.

Due to the different pattern direction of the elements 20 in each region 31, 32, 33, the colourshift effect will be exhibited over a different set of viewing positions in each case. For instance, the colourshift effect exhibited by second region 32 will be strongest when the device 10 is tilted about the x-axis, whilst that exhibited by the first region 31 will be strongest when the device has been rotated about the z-axis by 45 degrees and tilting then takes place about the first pattern direction PD₁. The result is a dynamic effect as the different appearances displaced by each respective region appear to change and switch in contrast. As shown in photographs 16(a), (b) and (c), each of which shows the device under direct off-axis illumination, from different viewing positions, due to the shape and configuration of the regions 31, 32, 33, the device as a whole has the appearance of a set of cubes. When the viewing position is changed, the various faces of the cubes appear to change in appearance giving rise to the impression that the cubes have rotated and/or the position of their illumination has moved.

Another example of a security device is shown in FIG. 17. As in the previous embodiment, here the device 10 comprises multiple regions 31, 32, 33, 34, 35, 36 and 37, with different pattern directions PD. Again, FIG. 17(a) shows an enlarged view of a central portion of the artwork and for simplicity each element is depicted as having only two portions but in practice there will also be an overlapping middle portion as before. In this example, each region defines a concentric portion of a hexagon shape. The first region 31, in the centre of the hexagon, has a first pattern direction PD₁ which is parallel to the x-axis. Working out from the centre, the second, third and fourth regions 32, 33, 34 have respective pattern directions PD₂, PD₃, PD₄, which are each angularly displaced from the reference direction (x-axis) by an constantly increasing increment ϕ, here 45 degrees. The sequence of pattern directions then repeats in the fifth, sixth and seventh regions 35, 36, 37.

Due to the manner in which the pattern direction changes in a consistent manner from one region of the device to the next adjacent region, upon tilting or rotating the device 10, the appearance of the regions also appears to change in sequence, from one region to the next. This gives the impression of movement, in this case a contracting/expanding effect as the various concentric portions of the hexagon become highlighted in sequence. This is illustrated in photographs 17(a), (b) and (c) which show the device under direct illumination from an off-axis position at three different viewing angles. Comparison of the photographs shows a “wave” sequence of bright regions alternating with dark regions which appears to move towards and away from the centre of the hexagon.

FIG. 18 shows another example of a security device 10 which operates on the same principle. Here, as shown best by the enlarged artwork in FIG. 18(a), which again omits the middle overlapping portion of each element 20 for clarity, the device 10 comprises multiple regions each having the shape of a chevron. In a first part R₁ of the device, the chevron-shaped regions 31a, 32a, 33a, 34a point to the right (+x direction), while in a second part R₂ of the device, the chevron-shaped regions 31b, 32b, 33b, 34b point in the opposite direction (−x direction). Four different pattern directions PD are used, with the elements 20 in regions 31a and b being along the first pattern direction PD₁ (x-axis), those in regions 32a and b along a second pattern direction PD₂, those in regions 33a and b along a third pattern direction PD₃, and those in regions 34a and b along a fourth pattern direction. Each pattern direction is angularly spaced from the next by an increment ϕ which here is 45 degrees. It will also be noted that the orientation of the elements differs between each region 31a, 32a, 33a, 34a in the first part R₁ of the device and its counterpart 31b, 32b, 33b, 34b in the second part R₂, in that the order of the materials is reversed (i.e. their orientations differ by 180 degrees). For example, comparing regions 31a and 31b it will be seen that the dark material is above the light material in region 31a (i.e. further along the y-axis), whereas the opposite is the case in region 31b.

The result is that, upon tilting, the various regions change in appearance giving rise to a movement effect which appears to take place simultaneous in opposite directions in part R₁ of the device and part R₂ of the device respectively. For instance, the chevrons in first part R₁ may appear to move in the +x direction while at the same time (i.e. during the same tilt motion) the chevrons in second part R₂ may appear to move in the −x direction. This is a result of the different behaviours of the various regions upon tilting/rotating the device and the order in which the regions have been arranged on the device 10.

A further example of a security device operating on the same principles is shown in FIG. 19. Again, FIG. 19(a) shows an enlarged portion of the artwork, of which a central section is shown still further enlarged in FIG. 19(a)(i) and an outer section in FIG. 19(a)(ii). The device comprises a repeating set of triangular regions 31, 32, the apexes of which meet at centre C of the device 10 and the sides of which correspond to radii r. As shown best in FIG. 19(a)(ii), in first regions 31, the elements have a first pattern direction PD₁ and in second regions 32, the elements have a second pattern direction PD₂. The pattern directions are annularly separated by angle ϕ, which here is about 60 degrees. The first and second regions 31, 32 alternate with one another around the circumference of the device, thereby appearing to form concentric “zig zag” rings. Upon tilting, as shown in the photographs of FIGS. 19(b), (c) and (d), the various regions exhibit colourshift effects in sequence, giving rise to the appearance of rotation. To add a further visual effect, in this example the spacing s between adjacent elements is also varied across the device. Thus, in the vicinity of the centre C, the elements are spaced from one another by a distance s₁, whereas towards the outer periphery of the device, the elements are spaced from one another by a distance s₂, which is smaller than s₁. This imposes a static variation in colour density across the device, the colour density being greater at the periphery of the device than at the centre. Of course, more complex variations in spacing s could also be employed, e.g. to superimpose a static image across the device which will be visible simultaneously with the movement effects described herein.

In the exemplary security devices described so far, the different behaviours of the various regions has been achieved by varying the orientation and/or pattern direction from one region to another. Another parameter which can be varied to achieve different behaviours is the amount of overlap between the materials making up each element 20—i.e. the proportion of the element 20 occupied by the middle portion 25. An example in which this is employed is shown in FIG. 20, in which the printed elements 20 again take the form of line elements, this time having an irregular shape. FIGS. 20(a) and 20(b) respectively show the sub-elements of the two materials 29a and 29b which make up the elements 20. Thus, FIG. 20(a) shows an array of curved-line first sub-elements each formed of first material 29a, which are elongate in the Y-axis direction and spaced from one another in the X-axis direction. It will be seen that the first sub-elements curve in the +x direction around the centre of the array (in the Y-axis direction). Similarly, FIG. 20(b) shows an array of curved-line second sub-elements each formed of second material 29b, which again are elongate in the Y-axis direction and spaced from one another in the X-axis direction (the pitch being the same as in the array of first sub-elements). The second sub-elements curve in the opposite direction to the first sub-elements, i.e. in the −x direction at the centre of the array.

To form the security device 10, the two arrays of sub-elements shown in FIGS. 20(a) and 20(b) are printed so as to overlap one another as shown in FIG. 20(c). As in previous artwork images, each resulting element is depicted as comprising only two portions corresponding to the two materials, but in practice there will also be a middle portion in which both materials are present. Due to the different curvature of the first and second sub-elements, the degree of overlap between the two materials 29a, b and the order of the materials left to right, varies along the Y-axis direction. This results in the creation of various regions 31, 32, 33, 34 with distinct behaviours.

In first region 31, the first material 29a forms the left edge of each element 20 and the second material the right, such that the region will exhibit a colourshift effect as previously described. For instance, if first material 29a is yellow and second material 29b is blue (on a silver-coloured reflective substrate 11), the colourshift will be yellow to blue. In second region 32, the two material entirely overlap one another (i.e. the middle portion occupies substantially the whole of the element), with the result that there is substantially no colourshift effect and the second region 32 will have a static colour corresponding to that of the mixed materials, e.g. green (continuing the above example). In the third region 33, the overlapping of the materials is once again only partial but now the second material 29b forms the left edges of the elements 20 and the first material 29a is on the right, so the region displays a colourshift effect which is reversed relative to that of the first region 31 (e.g. blue to yellow). Finally, in fourth region 34, the two materials 29a, b entirely overlap one another again and so a static colour (e.g. green) is exhibited. If the elements continue in the y-axis with the same repeating curvature, the same sequence of regions 31 to 34 will repeat along the length of the device.

Photographs of a device formed as just described are shown in FIGS. 20(d), (e) and (f) under directional illumination from three different viewing angles. Figures and (f) show the two extremes of the colourshift effect exhibited by the device, while FIG. 20(e) shows an intermediate position in which the contrast between regions is reduced. In each photograph, four wide horizontal bands can be discerned, demarcated by three narrow bands which corresponding to the static regions 32, 34 mentioned above. The wide bands correspond to regions 31 and 33 (two repeats of the full region sequence being visible). In FIG. 20(d), the wide band at the top of the photo appears blue while the next wide band appears yellow, whereas in FIG. 20(f) the reverse is true.

Another notable distinction between this device and those of previous embodiments is that in the FIG. 20 device, the transition from one region to the next is gradual—i.e. the amount of overlap varies continuously rather than in discrete steps. It should be noted that such gradual transitions can be implemented in all embodiments, e.g. by varying the pattern direction in small increments from one region to the next.

However, it is also possible to vary the overlap amount discretely between regions, and an example of a device formed in this way is shown in FIG. 21. Here, FIG. 21(a) depicts a portion of an array of first sub-elements, formed of first material 29a (e.g. blue), while FIG. 21(b) shows a portion of an array of second sub-elements, formed of a second material 29b (e.g. colourless). (It should be noted that a smaller portion of the device is shown in FIG. 21(b) as compared with FIG. 21(a)). As shown in FIG. 21(a), the rectilinear first sub-elements extend along the Y-axis direction and are spaced from one another in the X-axis direction with a pitch P. Four distinct regions 31, 32, 33, 34 are defined, with the sub-elements being shifted along the x-axis so as to provide a lateral offset Δ between the sub-elements in one region and those in the next. The array of second sub-elements, shown in FIG. 21(b), is continuous across all of the regions and simply comprises a set of rectilinear sub-elements with the same pitch P as those in the array of first sub-elements.

To form the security device, the first sub-elements of material 29a and the second sub-elements of material 29b are printed so as to overlap one another. The result is that the degree of overlap between the materials, and the order of materials, will vary from one region of the device to the next. For example, in first region 31, there is no overlap between the first sub-elements and the second sub-elements since the second sub-elements are located in the spaces s between the first sub-elements. Hence, the first region 31 will display a static colour and no colourshift effect. In second region 32, due to the lateral shift of the first sub-elements, there is overlap between the first and second materials, with the first material 29a forming the left edge of each element 20 and second material 29b the right. Hence, here a colourshift effect (e.g. blue to colourless) is exhibited on tilting. In the third region 33, the overlap between the two materials is near complete and so the appearance is static. In the fourth region 34, there is partial overlap with the second material 29b forming the left edge of each element 20 and the first material 29a forming the right edge, with the result that a colour shift effect opposite from that in second region 32 is exhibited (e.g. colourless to blue).

FIGS. 21(c), (d) and (e) are photographs showing the complete device under directional illumination from three different viewing angles. FIGS. 21(c) and (e) show the two extremes of the colourshift effect exhibited by the device, while FIG. 21(d) shows an intermediate position in which the contrast between regions is reduced. In each photograph, a series of concentric bands can be discerned, the colours of which appear to swap upon changing viewing position. This gives rise to a movement or “pulsing” effect towards or away from the centre of the device, depending on the direction of tilt.

Another technique by which the visual complexity of the security device can be increased is to provide at least some of the printed elements 20 making up the device with an overlay element 40. Overlay elements can be used to conceal or change the appearance of parts of the printed elements, e.g. to inhibit or alter the colourshift effect exhibited by the element 20. FIGS. 22, 23 and 24 show a printed element 20 made up of two materials, as described above, with an overlay element 40 provided thereon. It will be appreciated that the shape of the overlay element 40 is shown only schematically in the Figures and in practice its upper surface may also follow the contours of the raised element 20. In this example, the overlay element is opaque (e.g. black), but this is not essential. The overlay element 40 is configured so as to cover only part of the element 20, so that at least some of one or both of the edge portions remains visible. In the configuration shown in FIG. 22, the overlay element 40 is located over the centre of element 20, leaving part of both the first edge portion 24a and the second edge portion 24b uncovered. This configuration retains the extremes of the colourshift effect exhibited by element 20 but at other viewing positions, the element exhibits the appearance of overlay element 40. In the configuration shown in FIG. 23, the overlay element is shifted relative to printed element 20 such that it covers the first edge portion 24a and part of the middle portion 25, leaving the second edge portion 24b visible. This will inhibit part of the colour shift effect, causing the element to exhibit the appearance of overlay element 40 at most viewing angles, switching to that of the second material in second edge region 24b at certain positions. Likewise, in the configuration shown in FIG. 24 where the overlay element 40 covers the second edge portion 24b but not the first edge region 24a, the element will exhibit the appearance of overlay element 40 at most viewing angles, switching to that of the first material in first edge region 24b at certain positions.

This principle can be used to form devices which exhibit three or more colours upon tilting. An example will be described with reference to FIG. 25. Here, the first and second materials 29a, 29b making up the printed element 20 are yellow and magenta respectively, while overlay elements 40 comprise a semi-transparent material with a third colour such as cyan. FIG. 25(a) shows a portion of the artwork according to which the elements 20 are printed (as in previous embodiments, the overlapping middle portion of each element is not shown, for clarity). It will be seen that the elements 20 are rectilinear line elements parallel to the Y-axis, spaced along the X-axis with a pitch P, with the first material 29a (yellow) forming the left edge thereof, and the second material 29b (magenta) forming the right edge thereof. For instance, the first and second materials 29a, 29b may be formed with a design width of 100 microns each, the (design) spacing s₁ between the elements 20 being 50 microns. Three regions 31, 32, 33 are defined with the elements 20 being laterally offset by distance A (e.g. 30 microns) in the X-axis direction from one region to the next. It should be noted that both the first and second materials 29a, b are laterally offset by the same amount region to region, so the degree of overlap between the first and second materials remains the same in each region (unlike the situation in the FIG. 21 embodiment). A portion of the artwork according to which the overlay elements 40 are printed is shown in FIG. 25(b). The overlay elements 40 are also rectilinear elements parallel to the Y-axis and spaced along the X-axis at the same pitch P, the overlay elements 40 having a width smaller than that of the elements 20. For instance, each overlay element 40 may have a design width of 100 microns and be spaced from the next by 150 microns. The array of overlay elements 40 is continuous across all of the regions, without any interruption.

To form the security device 10, after the first and second materials 29a, 29b have been printed (and cured if necessary) to form the elements 20, the array of overlay elements 40 is printed so as to overlap the array of elements 20. This could be performed, for example, by an additional print head provided downstream of second print head 92b in the FIG. 12 apparatus. The part of the element 20 which is covered by the overlay element 40 will vary between regions, due to the lateral offset in the array of elements 20. For instance, in first region 31, the overlay element 40 is approximately centred on each colourshifting element 20, leaving both edge portions uncovered (as shown in FIG. 22). As such, here the appearance of the region 31 will appear to vary between magenta and yellow, with grey/black in between (caused by the combination of cyan, magenta and yellow).

In the second region 32, the overlay element 40 covers more of first material 29a, and in the third region 33 all of the first material 29a is covered by overlay element (as shown in FIG. 23). As such, here the appearance of the region 33 will vary between green (caused by the combination of cyan and yellow in first edge portion 24b) and magenta upon tilting. In another region (not shown), the opposite will be the case with the overlay element 40 covering second edge portion 24b. Here, the colourshift will be between yellow and purple (caused by the combination of cyan and magenta in edge portion 24b). The result is a multi-coloured colourshift effect.

FIGS. 25(c), (d), (e) and (f) are photographs of a device formed as just described. FIG. 25(c) shows the device in diffuse lighting, which appears largely black with little contrast, if any between regions, due to the human eye combining the roughly equal amounts of cyan, yellow and magenta ink present across the device. FIGS. 25 (d), (e) and (f) show the same device under directional illumination from three different viewing angles. FIGS. 25(d) and (f) show the extremes of the colour shift effect while FIG. 25(e) shows an intermediate position where the contrast is less apparent. In FIG. 25(d), concentric bands of blue, purple and black are visible. In FIG. 26(f), the bands now appear yellow, turquoise and black.

A further example of a security device operating on similar principles to that of the FIG. 25 embodiment will be described with reference to FIG. 26. In this case, the device comprises not only multiple regions in which the printed elements are laterally offset between one region and the next (as in FIG. 25), but also regions in which the printed elements have a different pattern direction and thus exhibit markedly different behaviour. FIG. 26(a) schematically shows a portion of the array of printed elements 20 in a first part of the device. Here, the printed elements are line elements, elongate parallel to the y-axis and spaced from one another in the x-axis. Each printed element 20 comprises first and second materials 29a, 29b such as cyan and magenta inks (respectively), which overlap in a middle portion (not shown). The printed elements 20 are increasingly laterally offset in the x-direction, looking down the Figure from one region to the next (each “step” corresponds to one region). An array of overlay elements 40 is provided overlapping the array of elements 20, each overlay element 40 comprising a straight line element formed of a third material, e.g. yellow. Since all the materials are semi-transparent in this example, different mixed colours will be created at different positions along the array, depending on which material(s) of the printed element 20 are covered by the overlay element 40 and to what extent. As a result, this part of the device exhibits a multi-coloured, rainbow-like appearance, the various colours of which appear to move or switch position on tilting about the y-axis.

In another part of the device, of which a portion is shown in FIG. 26(b), the printed elements have the same construction but have a different pattern direction. The elongate direction of the elements 20 is now parallel to the x-axis, and the elements are spaced in the y-axis direction. Thus, the pattern direction in this second part of the device is perpendicular to that in the first part of the device. The second part of the device also exhibits a multi-coloured rainbow effect which appears to move upon tilting about the x-axis. Under directional light, the first and second parts of the device will redirect light in different directions (due to the different pattern direction) resulting in a clear contrast between the parts.

This is illustrated by photographs of a security device formed according to the above principle, shown in FIGS. 26(c), (d), (e) and (f). Here, the first part of the device forms a background area to a second part of the device which has the form of the repeating word “GENUINE”. That is, in the background part the printed elements have a first direction (FIG. 26(a)) while inside the letters “GENUINE” the printed elements have a second direction which is perpendicular to the first (FIG. 26(b)). FIG. 26(c) show the appearance of the device under diffuse illumination and it will be seen that the device appears dark and featureless.

FIG. 26(d) shows the device under direct illumination from a first direction as it appears at a first viewing position, which causes the first part of the device (background) to appear dark since there the printed elements are directing light away from the viewer. Meanwhile, the letters “GENUINE” appear bright and multi-coloured.

FIGS. 26(e) and (f) show the security document rotated through 90 degrees relative to the light source, and viewed from two different viewing angles (or, equivalently, at the same viewing angle but tilting the incident light from one side to the other). Now, the background area appears bright and multi-coloured, while the letters “GENUINE” appear dark. The colours in the background area appear to move between the two viewing positions as a result of the colourshift effect.

It will be appreciated that a photocopy or scan of the device will appear dark, featureless and optically invariable since the complex construction of each printed element will not be reproduced and the printed elements in the copy will not have the necessary relief structure.

In the examples of FIGS. 25 and 26, the printed elements 20 formed of two (or more) materials have been configured to undergo a lateral offset from one region to the next, and the overlay elements 40 have been shown as having no offset. However, it should be appreciated that the same results can be achieved by the reverse arrangement—that is, providing the lateral offset in the overlay elements instead of in the printed elements 20. Likewise, the same or similar effects can be achieved by providing both arrays (the printed elements 20 and the overlay elements 40) with lateral offsets between regions. Any of these options can be used to ensure the edge colours of the elements (given by the two sides of the printed element 20 alone or in combination with the overlay elements 40) vary across the array, which gives rise to the described visual effects.

The visual effects achieved in the embodiments of FIGS. 25 and 26 can alternatively be achieved using the principles described with reference to FIGS. and 21 instead of overlay elements. In this scenario, the artwork is as already shown in FIGS. 25(a), (b) and FIGS. 26(a), (b) but there is little or no overlap between the first and second materials 29a, 29b, and hence these do not by themselves form a raised printed element 20 of the sort required in the present invention (in practice, there may typically be some overlap due to ink spread). Rather, it is the material shown as overlay elements 40 in FIGS. 25(a), (b) and FIGS. 26(a), (b) which provides the overlap and, together with one or both of the first and second materials 29a, 29b, forms the raised printed element as described previously. Hence, in this case the overlay elements 40 are better thought of as a third material forming part of the printed elements 20. This is equivalent to modifying the FIG. 21 embodiment such that the array shown in FIG. 21(a) comprises line pairs of two (substantially non-overlapping) materials—the second array shown in FIG. 21(b) will then overlap different ones of those materials (or a portion of each) to different extents in different regions, forming the necessary raised profile element and resulting in a visual appearance similar to that of the FIG. 25 embodiment. Likewise, modifying the FIG. 20 embodiment such that the FIG. 20(a) array comprises line pairs of two (substantially non-overlapping) materials, will result in a similar visual appearance to (one region of) the FIG. 26 embodiment.

In the examples described so far, all of the printed elements 20 making up the array are made of the same materials as one another. That is, the same first material 29a is present in every one of the elements, as is the same second material 29b. It is the arrangement of the materials in each element and/or the positioning of each element (e.g. pattern direction or lateral offset) which differs across the array to give rise to any information content displayed (as a result of contrast between different regions of the device). However, in other embodiments different elements 20 may comprise different materials from one another, with different optical characteristics. For example, in one region of the security device, the first material 29a in each element 20 may be a red ink, whereas in another region of the security device, the first material 29a in each element 20 may be a blue ink. The materials forming the elements 20 can be varied across the device as desired.

This principle provides an alternative way to arrange for one or more images to be exhibited by the security device, since the two or more edge portions 24a, 24b of each respective printed element 20 can act as pixels, displaying points of an image. Specifically, all of the first edge portions 24a across the security device can be configured to display points of a first image, while all of the second edge portions 24b across the security device can be configured to display points of a second image. When the security device is viewed from a first viewing position, at which the observer receives light reflected at the first edge portions 24a of each element 20 (e.g. observer O₁ in FIG. 3), the variation in optical characteristics caused by the use of different materials to form those edge portions results in the first image being displayed to the observer across the device. Likewise, when the security device is viewed from a second, different, viewing position, at which the observer receives light reflected at the second edge portions 24b of each element (e.g. observer O₂ in FIG. 3), the second image is apparent. Each of the first and second image could take any desirable form, e.g. alphanumeric text, a logo, a photographic portrait, etc.), and could be monochromatic (if the materials used are a coloured ink and a colourless ink), or multi-coloured (if multiple inks with different visible colours are used).

An example in which this principle is supplemented by the (optional) provision of an array of overlay elements 40 will now be described with reference to FIG. 27. In this case, each printed element 20 has a triangular lateral shape and is formed of three materials, as described with reference to FIG. 10 above. The printed elements 20 are arranged on a regular hexagonal grid as shown in FIG. 27(a). Each printed element 20 has a first edge portion 24a forming (approximately) the top-left third of the element 20, a second edge portion 24b forming the top-right third, and a third edge portion 24c forming the bottom third. The number of materials forming each element 20 may vary across the device 10, but at a minimum at least some of the elements 20 (preferably all) will each comprise at least two different materials forming respective edge portions, so that they exhibit a colourshift effect as previously described. In this example, some of the elements in the array will comprise a different material forming each of the three edge portions 24, others only two (if two of the edge portions are formed of the same material) and some only one (of all three of the edge portions are formed of the same material).

Each of the first edge portions 24a is allocated a material according to a first image, which here is an image of the digits “50” against a uniformly coloured background (e.g. a yellow “50” surrounded by a cyan background). Thus, within a region with a periphery forming the digits “50”, the first edge portions 24a of the elements 20 are formed of a yellow first material, while outside that region the first edge portions 24a of the elements 20 are formed of a cyan first material. Each of the second edge portions 24b is arranged to represent pixels of a second image, which here is an image of the digits “20” against a uniformly coloured background (e.g. a cyan “20” surrounded by a magenta background). Thus, within a region with a periphery forming the digits “20” (which partially overlaps the region forming the “50”), the second edge portions 24b of the elements 20 are formed of a cyan second material, while outside that region the second edge portions 24b of the elements 20 are formed of a magenta second material. Finally, each of the third edge portions 24c provides pixels of a third image, which in this example shows the digit “5” against a uniformly coloured background (e.g. a magenta “5” against a yellow background). So, within a region having a periphery defining the digit “5” (which partially overlaps the regions forming the “20” and the “50”), the third edge portions 24c are formed of a magenta third material, while outside that region the third edge portions 24c are formed of a yellow third material.

It will be understood that all the various edge portions formed of one material (e.g. cyan) can be printed in one step, followed by printing of all the edge portions formed of another material (e.g. magenta) and so on. That is, as in the method described with respect to FIG. 11, in the first printing step all of the sub-elements formed of one material can be laid down but it will be appreciated that the sub-elements may not (and will not, in the present embodiment) end up forming the same edge portion in every one of the elements 20. Hence the various sub-elements of any one material could have different shapes, sizes and/or orientations from one another.

Once the array of elements 20 are complete, in this example as shown in FIG. 27(b), an array of black overlay elements 40 is printed over the top, each overlay element 40 being triangular and approximately centred on each colourshifting element 20. The overlay elements 40 have a smaller lateral width than the colourshifting elements 20 so that while the middle portion 25 of each element 20 is covered, at least part of the first, second and third edge portions 24a, b, c of each element 20 is left uncovered. The provision of the array of overlay elements is optional but preferred in this case, since it helps to conceal the presence of the first, second and third images at normal viewing angles, thereby making the presence of the security effect more covert.

Thus, when the completed security device is viewed from the normal, the whole device appears black and substantially featureless. Upon tiling, the various images are revealed. FIGS. 27(c), (d) and (e) show the security device under directional illumination from three off-axis viewing positions at which the respective images are visible. In FIG. 27(c), the observer is at a position to which light reflected by the third edge portions 24c of the elements 20 is received, and hence the third image is exhibited across the device, i.e. a magenta “5” against a yellow background. FIG. 27(d) shows the device 10 from another viewing position at which light is received from the first edge portions 24a and so the first image (a yellow “50” against a cyan background) is revealed. FIG. 27(e) depicts the appearance of the device from another viewing position, to which light from the second edge portions 24b is directed, hence the second image is displayed (a cyan “20” against a magenta background). A detail of FIG. 27(e) is shown at enlarged scale to illustrate a portion of the element array, showing that the second edge portions 24b in region 31 are formed of a different material from the second edge portions 24b in region 32.

Security devices of the sort disclosed herein can be combined with other features provided on the substrate 11 (or on a security document to which the substrate 11 may ultimately be affixed, if formed separately). Of particular interest is the potential for interaction between features forming a window region (or half-window region) on security documents such as banknotes. Examples will now be described with reference to FIG. 28, in which the security device 10, comprising printed elements 20 and reflective layer 11 is depicted only schematically. Typically, a polymer document substrate for a security document 100 comprises a transparent polymer base substrate 105 with one or more layers of opacifying material 106a, 106b provided on one or both sides, such as a white or other light-coloured ink with high optical scattering. Typically the opacifying layers are applied by gravure printing. An example is shown in FIG. 28(a), in which the opacifying layers 106a, 106b are provided continuously across the base substrate 105 such that there is no window region. The security device 10 can be formed thereon, e.g. by printing or vapour-depositing a reflective layer 11 over a region of the opacifying layer and then printing the elements 20 on top (optionally followed by a protective layer, not shown). Alternatively, the reflective layer 11 can be provided as part of a multilayer substrate construction (as described with reference to FIG. 5) which is affixed to the surface of the document. In this case, the elements 20 can be printed onto the reflect substrate 11 before or after it is applied to the document 100. In this example there is no interaction between the device 10 and the surrounding document.

In the example shown in FIG. 28(b), the construction is the same as just described, except for the provision of a further opacifying layer 106c on the same side of the document as the security device 10, which extends partially over security device 10. That is, a portion 108 of the security device 10 is located between the document substrate and the uppermost opacifying layer 106c. Depending on the opacity of layer 106c, this may result in the colourshifting effect being muted or concealed by the opacifying layer 106c in region 108, although it preferably can still be seen in reflected light. This provides additional visual complexity to the device and hence increases the security level. The silhouette of the security device edge will also be visible in region 108 in transmitted light. If desired, the periphery of opacifying layer 106c can be configured so as to compliment certain aspects of the security device design. For instance, the periphery might coincide with a boundary between regions of the security device which exhibit different behaviours on tilting, if desired. This would demonstrate register between the printed elements 20 and the opacifying layer 106c.

The example shown in FIG. 28(c) will exhibit substantially the same visual effects as that depicted in FIG. 28(b). However, here instead of providing an additional opacifying layer to overlay part of device 10, the existing opacifying layer 106a is used for this purpose. Hence, in this case, the device 10 is applied to the base substrate 106 before opacifying layer 106a is applied over the top.

In the three last examples, the reflective layer 11 is provided on the same side of the base substrate 105 as the printed elements 20. However this is not essential and FIG. 28(d) shows an example in which they are on opposite sides of base substrate 105. For instance, reflective layer 11 may comprise a metallic ink printed across all or part(s) of one surface of the base substrate 105, while the elements are located on the opposite side. Preferably, the elements 20 are printed directly onto base substrate 105 although it is also possible to print them onto a thin transparent substrate (not shown) which is then affixed to the surface of base substrate 105. Finally, opacifying layers 106a, 106b may be applied to one or both sides of the construction.

Security devices of the sorts described above are suitable for forming on security articles such as labels, threads, stripes, patches, foils and the like which can then be incorporated into or applied onto objects of value including security documents such as banknotes and examples of this will be provided further below. However the security devices can also be constructed directly on such objects, in which case a surface of the object provides the substrate of the security device, with the elements being printed onto it (after a reflective layer is applied, if necessary). In the case of security documents, this includes conventional paper-based documents as well as those which are formed of a transparent document substrate, such as polymer banknotes. Other objects of value to which the security device may be applied (directly, or carried by a security article such as a label) include: packaging (such as pharmaceuticals or cigarette packaging), food and drink containers (such as beverage cans and beverage bottles), as well as goods themselves, such as cosmetics or electronic items.

In the case of security documents, a security article carrying a security device can be arranged either wholly on the surface of the base substrate of the security document, as in the case of a stripe or patch, or can be visible only partly on the surface of the document substrate, e.g. in the form of a windowed security thread. Security threads are now present in many of the world's currencies as well as vouchers, passports, travellers' cheques and other documents. In many cases the thread is provided in a partially embedded or windowed fashion where the thread appears to weave in and out of the paper and is visible in windows in one or both surfaces of the base substrate. One method for producing paper with so-called windowed threads can be found in EP-A-0059056. EP-A-0860298 and WO-A-03095188 describe different approaches for the embedding of wider partially exposed threads into a paper substrate. Wide threads, typically having a width of 2 to 6 mm, are particularly useful as the additional exposed thread surface area allows for better use of optically variable devices, such as that presently disclosed.

The security article may be incorporated into a paper or polymer base substrate so that it is viewable from both sides of the finished security substrate at at least one window of the document. Methods of incorporating security elements in such a manner are described in EP-A-1141480 and WO-A-03054297. In the method described in EP-A-1141480, one side of the security element is wholly exposed at one surface of the substrate in which it is partially embedded, and partially exposed in windows at the other surface of the substrate.

Base substrates suitable for making security substrates for security documents may be formed from any conventional materials, including paper and polymer. Techniques are known in the art for forming substantially transparent regions in each of these types of substrate. For example, WO-A-8300659 describes a polymer banknote formed from a transparent substrate comprising an opacifying coating on both sides of the substrate. The opacifying coating is omitted in localised regions on both sides of the substrate to form a transparent region. In this case the transparent substrate can be an integral part of the security device or a separate security device can be applied to the transparent substrate of the document. WO-A-0039391 describes a method of making a transparent region in a paper substrate. Other methods for forming transparent regions in paper substrates are described in EP-A-723501, EP-A-724519, WO-A-03054297 and EP-A-1398174.

The security article may also be applied to one side of a paper substrate, optionally so that portions are located in an aperture formed in the paper substrate. An example of a method of producing such an aperture can be found in WO-A-03054297. An alternative method of incorporating a security element which is visible in apertures in one side of a paper substrate and wholly exposed on the other side of the paper substrate can be found in WO-A-2000/39391.

Examples of such documents of value and techniques for incorporating a security device will now be described with reference to FIGS. 29 to 32.

FIG. 29 depicts an exemplary document of value 100, here in the form of a banknote. FIG. 29a shows the banknote in plan view whilst FIG. 29b shows a cross-section of the same banknote along the lines Q-Q′. In this case, the banknote is a polymer (or hybrid polymer/paper) banknote, having a transparent base substrate 105. Two opacifying layers 106 are applied to either side of the transparent substrate 105, which may take the form of opacifying coatings such as white ink, or could be paper layers laminated to the substrate 105.

The opacifying layers 106 are omitted across a selected region 101 forming a window within which a security device 10 is located. In FIG. 20(b), the security device is disposed within window 101, with a focusing element array 48 reflective layer 11 arranged on one surface of the transparent substrate 105, and elements disposed thereon. As described above, the security device 10 could be manufactured on a separate reflective substrate 11 which is then laminated to the document substrate 105 in the window region 101, or could be manufactured directly on the document substrate 105 by applying a reflective material 11 to the document substrate 105 (which here takes the place of carrier 11b shown in FIG. 5), at least in the window region 105, and optionally all over the substrate, and then applying printed elements 20 thereto, using the above-described method.

It will be appreciated that, if desired, the window 101 could instead be a “half-window”, in which one of the opacifying layers 106 is continued over all or part of the device 10. Depending on the opacity of the opacifying layers, the half-window region will tend to appear translucent relative to surrounding areas in which opacifying layers are provided on both sides.

In FIG. 30 the banknote 100 is a conventional paper-based banknote provided with a security article 107 in the form of a security thread, which is inserted during paper-making such that it is partially embedded into the paper so that portions of the paper 109 lie on either side of the thread. This can be done using the techniques described in EP0059056 where paper is not formed in the window regions during the paper making process thus exposing the security thread 107 in window regions 101 of the banknote. Alternatively the window regions 101 may for example be formed by abrading the surface of the paper in these regions after insertion of the thread. It should be noted that it is not necessary for the window regions 101 to be “full thickness” windows: the thread 107 need only be exposed on one surface if preferred. The security device 10 is formed on the thread 107, which comprises a transparent carrier 11b with reflective layers 11a applied thereto, and elements 20 printed thereon. In this example, devices 10 are provided on both sides of the thread 107 but this is note essential. Windows 101 reveal parts of the device(s), which may be formed continuously along the thread. Alternatively several security devices could be spaced from each other along the thread, with different or identical effects displayed by each.

In FIG. 31, the banknote 100 is again a conventional paper-based banknote, provided with a strip element or insert 108. The strip 108 is based on a transparent substrate and is inserted between two plies of paper 109. The security device is formed by a reflectively layer 11 and array of elements 20 as before. One or both of the paper plies 109 are apertured across region 101 to reveal the security device, which in this case may be present across the whole of the strip 108 or could be localised within the aperture region 101. It should be noted that the rear ply need not be apertured and could be continuous across the security device (as shown).

A further embodiment is shown in FIG. 32 where FIGS. 32(a) and (b) show the front and rear sides of the document 100 respectively, and FIG. 32(c) is a cross-section. Security article 110 is a strip or band comprising a security device 10 according to any of the embodiments described above. The security article 110 is formed into a security document 100 comprising a fibrous substrate 109, using a method described in EP-A-1141480. The strip is incorporated into the security document such that it is fully exposed on one side of the document (FIG. 32(a)) and exposed in one or more windows 101 on the opposite side of the document (FIG. 32(b)). Again, the security device 10 is formed on the strip 110, which comprises a reflective layer 11 and element array 20 as previously described.

Alternatively a similar construction can be achieved by providing paper 109 with an aperture 101 and adhering the strip element 110 onto one side of the paper 109 across the aperture 101. The aperture may be formed during papermaking or after papermaking for example by die-cutting or laser cutting.

In still further embodiments, a complete security device could be formed entirely on one surface of a security document which could be transparent, translucent or opaque, e.g. a paper banknote irrespective of any window region.

The security device of the current invention can be made machine readable by the introduction of detectable materials in any of the layers or by the introduction of separate machine-readable layers. Detectable materials that react to an external stimulus include but are not limited to fluorescent, phosphorescent, infrared absorbing, thermochromic, photochromic, magnetic, electrochromic, conductive and piezochromic materials.

Additional optically variable devices or materials can be included in the security device such as thin film interference elements, liquid crystal material and photonic crystal materials. Such materials may be in the form of filmic layers or as pigmented materials suitable for application by printing. If these materials are transparent they may be included in the same region of the device as the security feature of the current invention or alternatively and if they are opaque may be positioned in a separate laterally spaced region of the device.

60. A security device, comprising:
a substrate having a reflective surface; and
a printed array of elements on a substantially flat area of the substrate, each element being formed of at least a first material which is at least semi-transparent and a second material, the first and second materials having different optical characteristics from one another, and each element having a raised surface profile relative to the substrate including at least first and second sides sloping from the top of the element to at least first and second respective edges of the element, at which the first and second sides meet a substantially flat base surface of the element parallel to the substrate, the first and second sides having different orientations from one another and each lying at an acute angle to the substrate normal as measured at the respective edge of the element;
wherein each element of the printed array comprises:
a first edge portion which defines at least the first edge, part of the first side of the element, and part of the flat base surface of the element, and which is formed substantially only of the first material, such that the optical characteristics of the first material control the appearance of light reflected by the reflective surface through the first edge portion;
a second edge portion which defines at least the second edge, part of the second side of the element, and part of the flat base surface of the element, and which is formed substantially only of the second material, such that the optical characteristics of the second material control the appearance of light reflected by the second edge portion or by the reflective surface through the second edge portion; and
a middle portion which is located between the first and second edge portions and across which at least the first and second materials are both present;
such that, under illumination by light from a fixed direction away from the substrate normal, when viewed from a first viewing angle the element appears to have substantially the optical characteristics of the first material and at a second viewing angle the element appears to have substantially the optical characteristics of the second material.

61. A security device according claim 60, wherein the first and second sides of each element each lie at an acute angle to the substrate normal as measured at the respective edge of the element which is greater than or equal to 60 degrees and less than 90 degrees.

62. A security device according to claim 60, wherein the top of each element has a height of at least 5 μm relative to the substrate.

63. A security device according to claim 60, wherein in each element, across the middle portion the first and second materials overlap one another or are mixed together.

64. A security device according to claim 60, wherein in each element, the first and second edge portions occupy approximately equal proportions of the lateral area of the element as one another.

65. A security device according to claim 60, wherein each element further comprises a third material and has different optical characteristics from those of the first and second materials, each element further including a third side sloping from the top of the element to a third respective edge of the element, the third side lying at an acute angle to the substrate normal as measured at the third edge of the element and having a different orientation from those of the first and second slides, wherein each element further comprises a third edge portion which defines at least the third edge and part of the third side of the element, and which is formed substantially only of the third material, such that the optical characteristics of the third material control the appearance of light reflected by the third edge portion or by the reflective surface through the third edge portion, and the middle portion further comprises the third material, such that, under illumination by light from a fixed direction away from the substrate normal, when the device is viewed from a third viewing angle the element appears to have substantially the optical characteristics of the third material.

66. A security device according to claim 60, further comprising an array of overlay elements, each overlay element covering part of one of the elements, at least part of one or more of the edge portions of each element remaining uncovered by the overlay element, wherein each overlay element is formed by an overlay material.

67. A security device according to claim 60, wherein the second material is at least semi-transparent.

68. A security device according to claim 60, wherein at least in a part of the device, every one of the elements comprises the same first material and the same second material.

69. A security device according to claim 60, wherein the substrate comprises a carrier layer and a reflective layer disposed thereon, the reflective layer forming the reflective surface of the substrate.

70. A security device according to claim 60, wherein in at least a first region of the security device, the elements have a same first configuration, such that under illumination by light from a fixed direction away from the substrate normal, when viewed from the first viewing angle the first region appears to have substantially the optical characteristics of the first material and at the second viewing angle the first region appears to have substantially the optical characteristics of the second material.

71. A security device according to claim 70, wherein in a second region of the security device, the elements of the printed array have a same second configuration which is different from the first configuration of the elements in the first region of the security device, such that, at least at one viewing angle, the appearance of the second region is different from the appearance of the first region.

72. A security device according to claim 71, wherein:
the orientation of the elements in the second region is different from that of the elements in the first region;
the elements have a lateral shape which defines a pattern direction of the array, the pattern direction lying in the plane of the security device, and the elements are arranged such that the pattern direction is different in the first and second regions;
the proportion of the lateral area of each element occupied by the middle portion in which the first and second materials are present is different in the first and second regions of the device; and/or
the first and/or second material(s) are different in the first region of the device relative to the first and/or second material(s), respectively, in the second region of the device, at least in terms of optical characteristics.

73. A security device according to claim 71, wherein in a third region of the security device, the elements of the printed array have a same third configuration which is different from the first configuration of the elements in the first region of the security device, and from the second configuration of the elements in the second region of the security device, such that, at least at one viewing angle, the appearances of the first, second and third regions are different.

74. A security device according to claim 71, wherein the security device comprises an array of overlay elements, each overlay element covering part of one of the elements, at least part of one or more of the edge portions of each element remaining uncovered by the overlay element, the array of overlay elements being uniform across all of the regions, and the elements in each region are laterally offset relative to the elements in the other region(s), such that the overlay elements cover different parts of the elements in each region thereby giving rise to different appearances of each region, at least at one viewing angle.

75. A security device according to claim 60, wherein the first edges of the elements are provided with respective first material(s) which vary in optical characteristics across the array in accordance with a first image, the first image being displayed by the elements in combination when the device is viewed at the first viewing angle.

76. A security article comprising a security device according to claim 60.

77. An object of value or a security article comprising a security device according to claim 60.

78. A method of manufacturing a security device, comprising:
providing a substrate having a reflective surface; and
printing an array of elements onto a substantially flat area of the substrate, each element being formed by:
a) printing a first material which is at least semi-transparent onto the substrate in the form of a first sub-element; and
b) printing a second material onto the substrate in the form of a second sub-element, the first and second materials having different optical characteristics from one another;
wherein the printing is configured such that the first sub-element and the second sub-element partially overlap one another, thereby forming an element of the array of elements;
whereby each element has a raised surface profile relative to the substrate including at least first and second sides sloping from the top of the element to at least first and second respective edges of the element, at which the first and second sides meet a substantially flat base surface of the element parallel to the substrate, the first and second sides having different orientations from one another and each lying at an acute angle to the substrate normal as measured at the respective edge of the element; and each element comprises:
a first edge portion which defines at least the first edge, part of the first side of the element, and part of the flat base surface of the element, and which is formed substantially only of the first material, such that the optical characteristics of the first material control the appearance of light reflected by the reflective surface through the first edge portion;
a second edge portion which defines at least the second edge, part of the second side of the element, and part of the flat base surface of the element, and which is formed substantially only of the second material, such that the optical characteristics of the second material control the appearance of light reflected by the second edge portion or by the reflective surface through the second edge portion; and
a middle portion which is located between the first and second edge portions and is formed of the overlapping first and second materials;
such that, under illumination by light from a fixed direction away from the substrate normal, when viewed from a first viewing angle the element appears to have substantially the optical characteristics of the first material and at a second viewing angle the element appears to have substantially the optical characteristics of the second material.

79. A method according to claim 78, wherein the first and second materials are curable materials, and the method further includes at least one step of exposing the first and second materials to curing energy to thereby cure the first and second materials.

80. A method according to claim 79, wherein the first material is at least partially cured before the second material is printed onto the substrate, and then the second material is cured.

81. A method according to claim 78, wherein the printing is performed by a digital print method.

82. A method according to claim 78, wherein in step (a) the first material is printed to form an array of first sub-elements, and in step (b) the second material is printed to form an array of second sub-elements, at least some of the first sub-elements and second sub-elements partially overlapping one another to form elements of the array.

83. A method according to claim 78, wherein steps (a) and (b) are performed in register with one another.
